(19) United States
(12) Patent Application Publication
(10) Pub. No.: US 2018/0110046 A1
(43) Pub. Date: Apr. 19, 2018

(54) PROCEDURE FOR DYNAMICALLY CHANGING OPERATING PARAMETERS OF A BASIC SERVICE SET (BSS)

(71) Applicant: QUALCOMM Incorporated, San Diego, CA (US)

(72) Inventors: Abhishek Pramod Patil, San Diego, CA (US); Alfred Asterjadhi, San Diego, CA (US); George Cherian, San Diego, CA (US); Alireza Raissinia, Monte Sereno, CA (US); Ravi Gidvani, Fremont, CA (US)

(21) Appl. No.: 15/719,446

(22) Filed: Sep. 28, 2017

Related U.S. Application Data
(60) Provisional application No. 62/410,198, filed on Oct. 19, 2016.
(60) Provisional application No. 62/488,652, filed on Apr. 21, 2017.

(51) Int. Cl. H04W 72/04

(52) U.S. Cl. CPC H04W 72/0446; H04W 84/12

(57) ABSTRACT

This disclosure provides systems, methods and apparatuses for dynamically changing one or more operating parameters of a wireless network. In some aspects, an AP may detect the presence of an overlapping BSS having the same color as its own BSS. Upon detecting a color collision, the AP may temporarily disable color-related features (such as intra-PPDU power save, multi-NAV operation, spatial reuse, and the like) of its associated STAs. If the color collision persists beyond a threshold duration, the AP may dynamically change the color of its own BSS to a different BSS color. In some other aspects, the AP may detect the presence of an overlapping BSS having the same TBTT as its own. Upon detecting a beacon collision, the AP may expedite or delay the timing of its own TBTT so that it does not interfere or overlap with the TBTT of another BSS.

### CROSS-REFERENCE TO RELATED APPLICATIONS

This patent application claims priority to U.S. Provisional Patent Application No. 62/410,198 entitled “PROCEDURE FOR BASIC SERVICE SET (BSS) COLOR CHANGE” filed on Oct. 19, 2016 and to U.S. Provisional Patent Application No. 62/488,652 entitled “PROCEDURE FOR BASIC SERVICE SET (BSS) COLOR CHANGE” filed on Apr. 21, 2017, all assigned to the assignee hereof. The disclosures of all prior applications are considered part of and are incorporated by reference in this patent application.

### TECHNICAL FIELD

This disclosure relates generally to wireless networks, and specifically to changing one or more operating parameters of a wireless network.

### DESCRIPTION OF THE RELATED TECHNOLOGY

A wireless local area network (WLAN) may be formed by one or more access points (APs) that provide a shared wireless communication medium for use by a number of client devices or stations (STAs). Each AP, which may correspond to a Basic Service Set (BSS), periodically broadcasts beacon frames to enable any STAs within wireless range of the AP to establish and/or maintain a communication link with the WLAN. In a typical BSS, only one device (such as a STA or an AP) may access the wireless medium at any given time, and a STA may be associated with only one AP at a time. WLANs that operate in accordance with the IEEE 802.11 family of standards are commonly referred to as Wi-Fi networks.

In a typical WLAN, wireless devices (such as APs and STAs) may compete for access to the wireless communication medium. For example, the devices may use carrier sense multiple access collision avoidance (CSMA/CA) techniques to “listen” to the wireless medium to determine when the wireless medium is idle. When the wireless medium has been idle for a given duration, the devices may “contend” for medium access (such as by waiting a random “back-off” period before attempting to transmit on the wireless medium). The winning device may be granted exclusive access to the shared wireless medium for a period of time commonly referred to as a transmit opportunity (TXOP), during which only the winning device may transmit (and/or receive) data over the shared wireless medium.

A wireless device may detect that the wireless medium is busy if the energy level in the medium exceeds a packet detection threshold. For example, while one device is transmitting, other devices in the WLAN may detect the energy from such transmissions and refrain from accessing the wireless medium. In dense deployment scenarios, multiple APs may be located within close proximity of one another. This may result in “overlapping” BSSs. Although CSMA/CA techniques may be useful for preventing collisions in a single BSS environment, transmissions by a wireless device in one BSS may hinder or otherwise interfere with communications in an overlapping BSS (OBSS). Thus, there is a need to improve the throughput of communications in dense deployment scenarios.

### SUMMARY

The systems, methods and devices of this disclosure each have several innovative aspects, no single one of which is solely responsible for the desirable attributes disclosed herein.

One innovative aspect of the subject matter of this disclosure can be implemented in a method of dynamically changing one or more operating parameters of a basic service set (BSS). The method may include steps of detecting a conflict between one or more operating parameters of a first BSS and corresponding operating parameters of a second BSS, determining times at which one or more wireless stations (STAs) associated with the first BSS are available to receive communications from the first BSS, and dynamically changing the one or more operating parameters of the first BSS based at least in part on the times at which the one or more STAs are available to receive communications from the first BSS. For example, the times may be based at least in part on respective wake-up schedules of the one or more STAs.

In some implementations, the step of detecting a conflict between one or more operating parameters of the first BSS and corresponding operating parameters of the second BSS may further include steps of intercepting communications from the second BSS and determining, based on the intercepted communications, that the one or more operating parameters of the first BSS are the same as the corresponding operating parameters of the second BSS. In some other implementations, the step of detecting a conflict between one or more operating parameters of the first BSS and corresponding operating parameters of the second BSS may further include steps of receiving a report from a STA associated with the first BSS and determining, based on information included in the report, that the one or more operating parameters of the first BSS are the same as the corresponding operating parameters of the second BSS.

In some implementations, the step of dynamically changing the one or more operating parameters of the first BSS may further include steps of selecting new values for the one or more operating parameters, communicating the new values for the one or more operating parameters to the one or more STAs associated with the first BSS, and implementing the new values for the one or more operating parameters at a scheduled time. In some aspects, the scheduled time may be configured to coincide with at least one of a target beacon transmission time (TBTT) of the first BSS or a target wake time (TWT) of the one or more STAs. Further, in some aspects, the scheduled time may be indicated in one or more communication frames transmitted to each of the one or more STAs, wherein each of the one or more communication frames includes a countdown timer indicating a number of TBTTs remaining until the scheduled time.

The one or more operating parameters may include a BSS color of the first BSS. In some implementations, the step of dynamically changing the one or more operating parameters of the first BSS may further include steps of disabling one or more features related to the BSS color of the first BSS upon detecting that the first BSS and the second BSS have the same BSS color, and re-enabling the one or more features when the conflict is no longer detected in the BSS color of the first BSS. For example, the one or more features may include at least one of spatial reuse, multiple-network allocation vector (multi-NAV) operation, or intra-physical layer convergence procedure protocol data unit (intra-PPDU) power save. In some other implementations, the step of dynamically changing the one or more operating parameters of the first BSS may further include steps of determining that the first BSS and the second BSS have the same BSS color after a threshold period has elapsed, and selecting a new BSS color for the first BSS upon determining that the first BSS and the second BSS have the same BSS color after a threshold period has elapsed.

The one or more operating parameters also may include a TBTT of the first BSS. In some implementations, the step of dynamically changing the one or more operating parameters of the first BSS may further include a step of expediting or delaying the TBTT of the first BSS upon detecting that the TBTT of the first BSS coincides with the TBTT of the second BSS. In some aspects, the expediting or delaying of the TBTT may be performed by incrementally adjusting the TBTT of the first BSS, over a second duration, until the TBTT of the first BSS is offset relative to the TBTT of the second BSS by a threshold amount. For example, the second duration may correspond to at least one of a plurality of beacon intervals or a plurality of delivery traffic indication message (DTIM) periods.

Another innovative aspect of the subject matter described in this disclosure can be implemented in a wireless device (such as an AP). The wireless device includes one or more processors and a memory storing instructions that, when executed by the one or more processors, cause the wireless device to detect a conflict between one or more operating parameters of a first BSS and corresponding operating parameters of a second BSS, determine times at which one or more STAs associated with the first BSS are available to receive communications from the first BSS, and dynamically change the one or more operating parameters of the first BSS based at least in part on the times at which the one or more STAs are available to receive communications from the first BSS.

In some implementations, execution of the instructions for detecting the conflict may cause the wireless device to intercept communications from the second BSS and determine, based on the intercepted communications, that the one or more operating parameters of the first BSS are the same as the corresponding operating parameters of the second BSS. In some other implementations, execution of the instructions for detecting the conflict may cause the wireless device to receive a report from a STA associated with the first BSS and determine, based on information included in the report, that the one or more operating parameters of the first BSS are the same as the corresponding operating parameters of the second BSS.

In some implementations, execution of the instructions for dynamically changing the one or more operating parameters may cause the wireless device to select new values for the one or more operating parameters, communicate the new values for the one or more operating parameters to the one or more STAs associated with the first BSS, and implement the new values for the one or more operating parameters at a scheduled time. In some aspects, the scheduled time may be configured to coincide with a TBTT of the first BSS or a TWT of the one or more STAs. Further, in some aspects, the scheduled time may be indicated in one or more communication frames transmitted to each of the one or more STAs, wherein each of the communication frames includes a countdown timer indicating a number of TBTTs remaining until the scheduled time.

The one or more operating parameters may include a BSS color of the first BSS. In some implementations, execution of the instructions for dynamically changing the one or more operating parameters of the first BSS may further cause the wireless device to disable one or more features related to the BSS color of the first BSS upon detecting that the first BSS and the second BSS have the same BSS color, and re-enable the one or more features when the conflict is no longer detected in the BSS color of the first BSS. For example, the one or more features may include at least one of spatial reuse, multi-NAV operation, or intra-PPDU power save. In some other implementations, execution of the instructions for dynamically changing the one or more operating parameters of the first BSS may further cause the wireless device to determine that the first BSS and the second BSS have the same BSS color after a threshold period has elapsed, and select a new BSS color for the first BSS upon determining that the first BSS and the second BSS have the same BSS color after the threshold period has elapsed.

The one or more operating parameters also may include a TBTT of the first BSS. In some implementations, execution of the instructions for dynamically changing the one or more operating parameters of the first BSS may further cause the wireless device to expedite or delay the TBTT of the first BSS upon detecting that the TBTT of the first BSS coincides with the TBTT of the second BSS. In some aspects, the expediting or delaying of the TBTT may be performed by incrementally adjusting the TBTT of the first BSS, over a second duration, until the TBTT of the first BSS is offset relative to the TBTT of the second BSS by a threshold amount. For example, the second duration may correspond to at least one of a plurality of beacon intervals or a plurality of DTIM periods.

Another innovative aspect of the subject matter described in this disclosure can be implemented in a method of reporting conflicts detected between the operating parameters of two or more BSSs. The method may include steps of detecting a conflict between one or more operating parameters of a first BSS and corresponding operating parameters of a second BSS, reporting the conflict to an AP associated with the first BSS, and receiving a response from the AP indicating changes to the one or more operating parameters based at least in part on the reported conflict.

In some implementations, the step of detecting a conflict between one or more operating parameters of the first BSS and corresponding operating parameters of the second BSS may include steps of intercepting communications from the second BSS and determining, based on the intercepted communications, that the one or more operating parameters of the first BSS are the same as the corresponding operating parameters of the second BSS.

The response from the AP may include new values for the one or more operating parameters. In some implementations, the method may further include a step of implementing the new values for the one or more operating parameters at a scheduled time. In some aspects, the scheduled time may be indicated in one or more communication frames received from the AP, where each of the one or more communication frames includes a countdown timer indicating a number of TBTTs remaining until the scheduled time.

The one or more operating parameters may include a BSS color or a TBTT of the first BSS. In some implementations, the method may further include a step of disabling one or more features related to the BSS color, when communicating with the first BSS, based on the response from the AP. For example, the one or more features may include at least one of spatial reuse, multi-NAV operation, or intra-PPDU power save.

Another innovative aspect of the subject matter described in this disclosure can be implemented in a wireless device (such as a STA). The wireless device includes one or more processors and a memory storing instructions that, when executed by the one or more processors, cause the wireless device to detect a conflict between one or more operating parameters of a first BSS and corresponding operating parameters of a second BSS, report the conflict to an AP associated with the first BSS, and receive a response from the AP indicating changes to the one or more operating parameters based at least in part on the reported conflict.

In some implementations, execution of the instructions for detecting the conflict between one or more operating parameters of the first BSS and corresponding operating parameters of the second BSS may cause the wireless device to intercept communications from the second BSS and determine, based on the intercepted communications, that the one or more operating parameters of the first BSS are the same as the corresponding operating parameters of the second BSS.

The response from the AP may include new values for the one or more operating parameters. In some implementations, execution of the instructions may further cause the wireless device to implement the new values of the one or more operating parameters at a scheduled time. For example, the scheduled time may be indicated in one or more communication frames received from the AP, wherein each of the one or more communication frames includes a countdown timer indicating a number of TBTTs remaining until the scheduled time.

The one or more operating parameters may include a BSS color or a TBTT of the first BSS. In some implementations, execution of the instructions may further cause the wireless device to disable one or more features related to the BSS color, when communicating with the first BSS, based on the response from the AP. For example, the one or more features may include at least one of spatial reuse, multi-NAV operation, or intra-PPDU power save.

### BRIEF DESCRIPTION OF THE DRAWINGS

FIG. 1 shows a block diagram of an example wireless system.

FIG. 2A shows a timing diagram depicting an example basic service set (BSS) color collision detection operation.

FIG. 2B shows a timing diagram depicting an example BSS color change operation.

FIG. 3 shows a timing diagram depicting an example BSS color change operation.

FIG. 4 shows a timing diagram depicting an example BSS color change operation.

FIG. 5 shows an example BSS color change announcement element.

FIG. 6 shows a timing diagram depicting an example BSS color change operation.

FIG. 7 shows an example BSS color change announcement element.

FIG. 8 shows a timing diagram depicting an example TBTT adjustment operation.

FIG. 9 shows a timing diagram depicting an example TBTT adjustment operation.

FIG. 10 shows an example BSS color change announcement element including TBTT adjustment information.

FIG. 11 shows a timing diagram depicting an example BSS color change and TBTT adjustment operation.

FIG. 12 shows a timing diagram depicting an example BSS color change and TBTT adjustment operation.

FIG. 13 shows a timing diagram depicting an example BSS color change and TBTT adjustment operation.

FIG. 14 shows a block diagram of an example wireless device.

FIG. 15 shows a flowchart depicting an example operation for dynamically changing one or more operating parameters of a BSS.

FIG. 16 shows a flowchart depicting an example operation for changing the BSS color of a BSS when a color collision is detected with an overlapping BSS.

FIG. 17 shows a flowchart depicting an example operation for changing the TBTT of a BSS when a beacon collision is detected with an overlapping BSS.

FIG. 18 shows a flowchart depicting another example operation for changing the TBTT of a BSS when a beacon collision is detected with an overlapping BSS.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

The IEEE 802.11ax specification defines a BSS color indicator that may be used to differentiate BSSs in dense deployment scenarios. The BSS color indicator may be included in a physical layer (PHY) header (such as a high efficiency signaling A (HE SIG A) field) of communication frames exchanged between wireless devices (such as an AP and a STA). Since the BSS color indicator is provided in the PHY header, a STA that is within wireless range of two overlapping BSSs may quickly differentiate wireless communications intended for its own BSS (intra-BSS) from wireless communications intended for an overlapping BSS (inter-BSS) by inspecting the BSS color of any received communication frame. However, because there are a finite number of “colors” to choose from (the IEEE 802.11ax specification defines the BSS color indicator as a 6-bit value), there may be instances where some overlapping BSSs have the same color. As a result, STAs may have difficulty differentiating intra-BSS communications from inter-BSS communications. Furthermore, APs of overlapping BSSs may broadcast beacon frames at the same (or overlapping) times, causing inter-BSS beacons to interfere with intra-BSS beacons. Thus, it may be desirable to detect instances where overlapping BSSs have the same color (referred to hereinafter as a “color collision”) or target beacon transmission time (TBTT), and to take appropriate remedial action when a color or beacon collision is detected.

Some implementations described herein may enable an AP to detect the presence of an overlapping BSS having the same color as its own BSS. In some aspects, the AP may detect a color collision by intercepting wireless communications from neighboring BSSs. In some other aspects, an associated STA may notify the AP of a color collision. Upon detecting a color collision, the AP may temporarily disable color-related features (such as intra-PPDU power save, multi-NAV operation, spatial reuse, and the like) of its associated STAs. If the AP no longer detects the color collision after a threshold duration, the AP may subsequently re-enable the color-related features of its associated STAs. However, if the color collision persists beyond the threshold duration, the AP may dynamically change the color of its own BSS. More specifically, the AP may select a new color that is different than the color of any overlapping BSSs. Then, after performing the color change, the AP may re-enable the color-related features of its associated STAs.

In some other implementations, an AP may detect the presence of an overlapping BSS having the same TBTT as its own. In some aspects, the AP may detect a beacon collision by intercepting beacon frames broadcast by neighboring BSSs. In some other aspects, an associated STA may notify the AP of a beacon collision. Upon detecting a beacon collision, the AP may dynamically adjust the timing of its own TBTT so that it does not interfere or overlap with the TBTT of another BSS. For example, the AP may expedite or delay its TBTTs to offset the timing at which intra-BSS beacons are broadcast relative to the inter-BSS beacons from an overlapping BSS. In some implementations, an AP may leverage the BSS color change mechanism described herein to perform TBTT adjustment operations. Accordingly, the AP may perform a TBTT adjustment operation concurrently with a BSS color change operation.

Particular implementations of the subject matter described in this disclosure can be implemented to realize one or more of the following potential advantages. The throughput of communications in dense deployment scenarios (such as in the presence of overlapping BSSs) may be improved. For example, by dynamically changing the color of a particular BSS, the wireless devices (such as APs and STAs) may be able to benefit from color-related functionality (such as intra-PPDU power save, multi-NAV operation, spatial reuse, and the like) even in dense deployment scenarios. Further, by waiting a threshold duration to perform any color change, the AP does not trigger a color change operation when a detected color collision may be attributed to mobile BSSs (such as provided by software-enabled APs) moving through the environment. Furthermore, by dynamically adjusting its TBTT, the AP may broadcast intra-BSS beacon frames at times when there is little or no interference from inter-BSS beacon broadcasts. This may allow the AP to ensure that connectivity is maintained with its associated STAs in the corresponding BSS.

In the following description, numerous specific details are set forth such as examples of specific components, circuits, and processes to provide a thorough understanding of the present disclosure. The term “overlapping BSS” or “OBSS” refers to any BSS that overlaps, at least in part, with another BSS to which a particular STA belongs; the term “intra-BSS” refers to any communication intended for the BSS to which a particular STA belongs; and the term “inter-BSS” refers to any communication intended for an overlapping BSS. The term “HE” may refer to a high efficiency frame format or protocol defined, for example, by the IEEE 802.11ax specification. Thus, the term “HE STA” may refer to STAs that operate according to the IEEE 802.11ax specification. In addition, although described herein in terms of exchanging data frames between wireless devices, the implementations may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs).

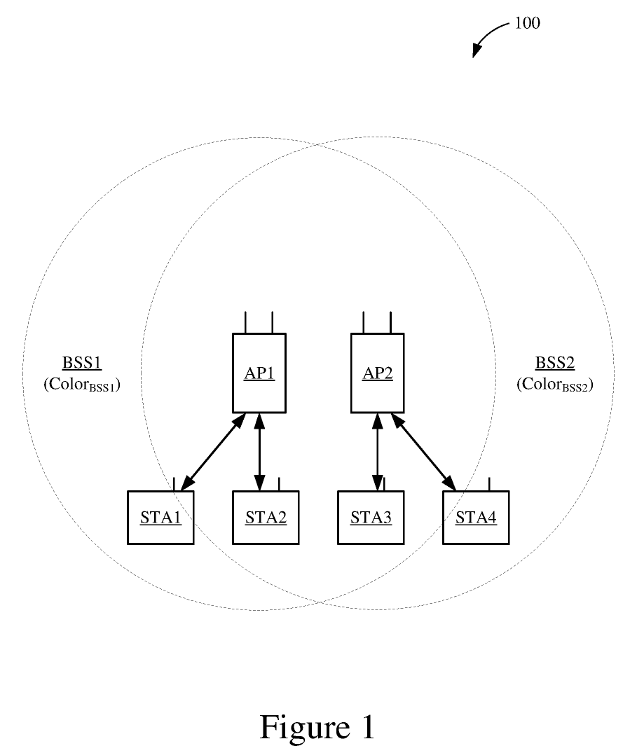

FIG. 1 shows a block diagram of a wireless system. The wireless system 100 is shown to include two access points AP1 and AP2 and a number of wireless stations STA1-STA4. Although only two access points AP1 and AP2, and four wireless stations STA1-STA4, are shown in the example of FIG. 1 for simplicity, it is to be understood that the wireless system 100 may include any number of APs and any number of STAs.

The wireless stations STA1-STA4 may include any suitable Wi-Fi enabled wireless device including, for example, a cell phone, personal digital assistant (PDA), tablet device, laptop computer, or the like. A STA also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some implementations, each of the wireless stations STA1-STA3 may include one or more transceivers, one or more processing resources (such as processors or ASICs), one or more memory resources, and a power source (such as a battery).

Each of the access points AP1 and AP2 may be any suitable device that allows one or more wireless devices to connect to a network (such as a local area network (LAN), wide area network (WAN), metropolitan area network (MAN), or the Internet) using Wi-Fi, Bluetooth, or any other suitable wireless communication standards. In some implementations, at least one of the access points AP1 or AP2 may be any suitable wireless device (such as a wireless STA) acting as a software-enabled access point (“SoftAP”). For at least one implementation, the access points AP1 and AP2 may include one or more transceivers, one or more processing resources (such as processors or ASICs), one or more memory resources, and a power source.

Each of the access points AP1 and AP2 may correspond to, or provide, a respective basic service set (BSS). Each BSS represents a basic building block of a wireless network, and may thus include a single AP and one or more associated STAs. For example, the first access point AP1 may form a first BSS (BSS1) that includes stations STA1 and STA2, and the second access point AP2 may form a second BSS (BSS2) that includes the stations STA3 and STA4. Accordingly, stations STA1 and STA2 may perceive any communications intended for BSS1 as intra-BSS communications, and may perceive any communications intended for BSS2 (or any other BSS) as inter-BSS communications. Similarly, stations STA3 and STA4 may perceive any communications intended for BSS2 as intra-BSS communications, and may perceive any communications intended for BSS1 (or any other BSS) as inter-BSS communications.

In the example of FIG. 1, the first basic service set BSS1 overlaps with the second basic service set BSS2 (due to the relatively close proximity of the access points AP1 and AP2). As a result, one or more operating parameters of the first basic service set BSS1 may be in conflict with corresponding operating parameters of the second basic service set BSS2. Such operating parameters may affect a timing or identification of communications in each BSS. Thus, when the overlapping basic service sets BSS1 and BSS2 have the same (or substantially similar) operating parameters, stations STA1 and STA2 may detect or intercept communications intended for BSS2 (such as between AP2 and STA3 or between AP2 and STA4). Similarly, stations STA3 and STA4 may detect or intercept communications intended for BSS1 (such as between AP1 and STA1 or between AP1 and STA2).

To help differentiate their respective BSSs, each AP may assign a particular color to its BSS. For example, the first access point AP1 may assign a color (Color_{BSS1}) to the first basic service set BSS1, and the second access point AP2 may assign a color (Color_{BSS2}) to the second basic service set BSS2. The BSS color information may be indicated in any communications intended for a particular BSS. For example, the IEEE 802.11ax specification defines a 6-bit BSS color indicator that may be included in a physical layer (PHY) header (such as a high efficiency signaling A (HE SIG A) field) of any communication frame. Thus, any communication frames exchanged between AP1, STA1, and STA2 may include a color indicator for Color_{BSS1}, and any communication frames exchanged between AP2, STA3, and STA4 may include a color indicator for Color_{BSS2}.

Since the BSS color indicator is provided in the PHY header, the stations STA1-STA4 may quickly differentiate intra-BSS communications from inter-BSS communications by simply inspecting the BSS color indicator of a received communication frame. This may allow the stations STA1-STA4 to implement a number of color-related features such as, for example, spatial reuse (STA may transmit and receive communication frames within its own BSS while concurrent wireless communications take place in an overlapping BSS), multiple-network allocation vector (multi-NAV) operation (STA maintains separate NAVs for inter-BSS communications and intra-BSS communications), intra-PLCP protocol data unit (intra-PPDU) power save (STA may enter or remain in a power save state based on knowledge of ongoing wireless communications in an overlapping BSS), and other color-related functionality.

As described above, there may be instances where the first basic service set BSS1 and the second basic service set BSS2 implement the same (or substantially similar) values for one or more operating parameters, especially in very dense deployment scenarios. For example, AP1 and AP2 may select the same color for their respective BSSs (such as where Color_{BSS1}=Color_{BSS2}), thus making it difficult for the stations STA1-STA4 to differentiate intra-BSS communications from inter-BSS communications. In some implementations, at least one of the access points AP1 or AP2 may detect that one or more of its operating parameters are in conflict with corresponding operating parameters of an overlapping BSS. For example, one of the access points AP1 or AP2 may determine that an overlapping BSS has the same color as its own BSS. When a conflict or “collision” is detected, the AP may then take appropriate remedial action to ensure that wireless communications within its own BSS may continue uninterrupted. In some implementations, the AP may dynamically change the values of the conflicting operating parameters based, at least in part, on an availability of its associated STAs to detect and implement the change.

In some aspects, the AP may detect conflicts or collisions with an overlapping BSS by intercepting communications from the overlapping BSS. For example, the AP may detect the color of an overlapping BSS by intercepting communication frames intended for an AP or STA belonging to the overlapping BSS and parsing the color identifier (such as provided in the PHY header) of the intercepted communication frames. The AP may then compare the color of the overlapping BSS with the color of its own BSS to determine whether a color collision exists. In some other aspects, the AP may detect conflicts or collisions with the operating parameters of an overlapping BSS based on reports received from one or more associated STAs. For example, a STA may intercept communications transmitted by wireless devices (such as APs or STAs) belonging to an overlapping BSS and determine that, although the color identifier of the received communication frame matches the color of its own BSS, the STA may not recognize other information in the received communication frame (such as a Basic Service Set Identifier (BSSID) or MAC address of the AP for the overlapping BSS). Thus, a color collision may be detected when a STA receives at least two communication frames with the same color identifier but conflicting additional information (suggesting that the communication frames are intended for, or originate from, two different APs). In some implementations, the STA may transmit an Event Report frame to the AP that indicates the BSS color of each overlapping BSS. In this manner, the STA may assist the AP in selecting a new non-overlapping BSS color to switch to.

Upon detecting a color collision, it may be desirable to change the color of at least one of the overlapping BSSs. However, it is noted that a color collision may be caused by a mobile device (such as a software-enabled AP (SoftAP)) moving through the environment. For example, the movement of a SoftAP may create temporary overlapping BSSs with another AP in the vicinity. Thus, in some implementations, an AP may temporarily disable one or more color-related features of its associated STAs (such as intra-PPDU power save, multi-NAV operation, spatial reuse, and the like) upon first detecting a color collision. However, if the color collision persists after a threshold period of time has elapsed (which suggests that the color collision is more permanent), the AP may then initiate a dynamic color change operation to change the color of its BSS to a new BSS color. For example, the AP may coordinate with its associated STAs to ensure that each of the STAs is appropriately notified of the change in BSS color.

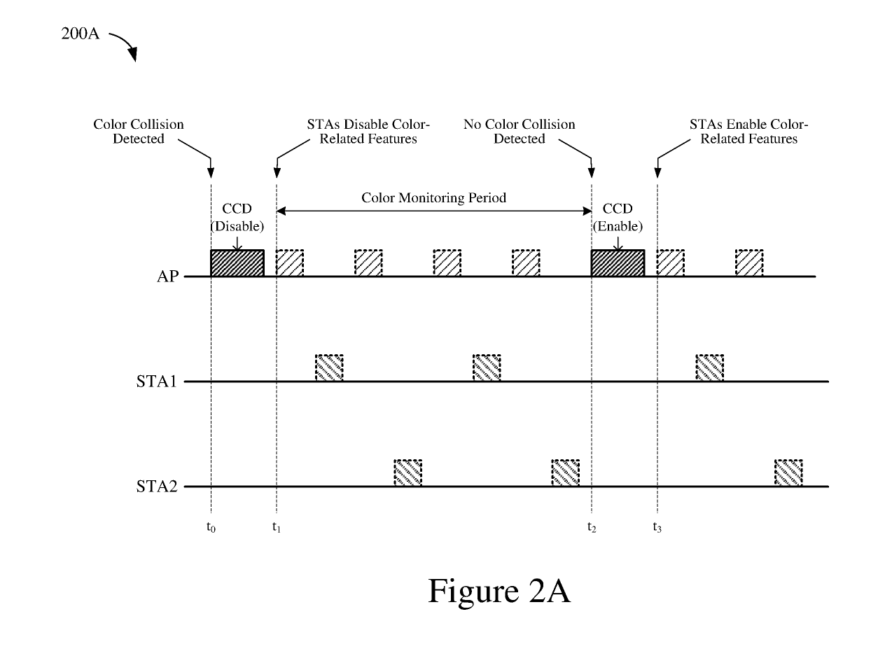

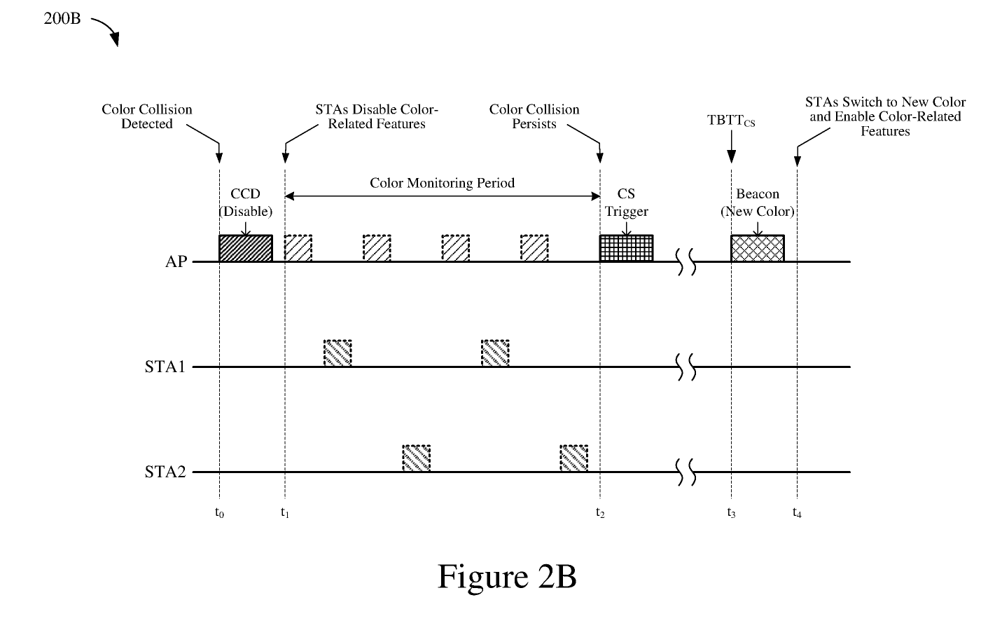

FIG. 2A shows a timing diagram 200A depicting a basic service set (BSS) color collision detection operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 2A. However, in some other implementations, the BSS may include fewer or more STAs than those depicted in the example of FIG. 2A.

The AP detects a color collision, at time t₀, and transmits a color collision detection (CCD) message to the stations STA1 and STA2. As described above, the AP may detect the color collision by analyzing the BSS color identifier of communication frames intended for an overlapping BSS. Alternatively, or in addition, the AP may be notified of the color collision by one or more of its associated stations STA1 or STA2. The AP may communicate the CCD message to each of the stations STA1 and STA2 via broadcast, multicast, or unicast communications. For example, the CCD message may be embedded in management frames, control frames, action frames, data frames, or other communication frames. In some implementations, the CCD message may correspond to a bit in the HE Operation element of frames communicated by the AP to the stations STA1 and STA2. The CCD message, as transmitted at time t₀, may indicate that the STAs should disable one or more color-related functions. For example, in one aspect, the AP may indicate that the STAs should disable their color-related functions by activating the corresponding bit in the HE Operation field of frames communicated to the stations STA1 and STA2.

After receiving the CCD message, at time t₁, each of the associated stations STA1 and STA2 may disable their respective color-related functions. In some implementations, the color-related features may be disabled for at least a threshold duration (referred to hereinafter as a “color monitoring period”), from times t₁ to t₂. As described above, the color monitoring period may allow the AP to determine whether the detected color collision is attributable to a temporarily overlapping BSS (or whether the color collision is expected to be more permanent). During the color monitoring period, the stations STA1 and STA2 may continue communicating with the AP (from times t₁ to t₂) in accordance with existing IEEE 802.11 standards, only without color-related functionality (such as intra-PPDU power save, multi-NAV operation, spatial reuse, and the like). In some aspects, any communications by the AP during the color monitoring period (from times t₁ to t₂) may include a CCD message indicating that the receiving STAs should continue to disable their color-related features.

When the color monitoring period expires, at time t₂, the AP may determine whether the color collision persists. In the example of FIG. 2A, the AP no longer detects a color collision when the color monitoring period expires. Accordingly, the AP may transmit another CCD message to the stations STA1 and STA2 to indicate that the STAs may re-enable their respective color-related functionality. As described above, the AP may communicate the CCD message to each of the stations STA1 and STA2 via broadcast, multicast, or unicast communications. The CCD message, as transmitted at time t₂, may indicate that the STAs can re-enable their color-related functions. For example, in one aspect, the AP may indicate that the STAs can re-enable their color-related functions by deactivating the corresponding bit in the HE Operation field of frames communicated to the stations STA1 and STA2. After receiving the CCD message, at time t₃, each of the stations may re-enable their respective color-related functions and resume normal communications with the AP.

However, if the AP detects that the color collision persists after the color monitoring period expires (at time t₂), the AP may subsequently trigger a BSS color change operation. For example, with reference to the example timing diagram 200B of FIG. 2B, the AP may transmit a color switch (CS) trigger message to the stations STA1 and STA2 upon determining that the color collision persists, at time t₂. The AP may communicate the CS trigger message to each of the stations STA1 and STA2 via broadcast, multicast, or unicast communications. For example, the CS trigger message may be embedded in management frames, control frames, action frames, data frames, or other communication frames. More specifically, the CS trigger message may indicate a time at which the color change operation is to occur (referred to hereinafter as a “color-switching” time).

It may be desirable to perform the color change operation at a time when all (or at least most) of the STAs of a particular BSS are listening to the AP. Thus, in some implementations, the AP may perform the color change operation during a target beacon transmission time (TBTT), when its associated STAs expect to receive a beacon frame from the AP. The CS trigger message may specify or otherwise indicate a particular TBTT (TBTT_{CS}) at which the BSS color change is to occur. In some aspects, the color-switching time (TBTT_{CS}) may coincide with a Delivery Traffic Indication Map (DTIM) period, when most (if not all) of the STAs are expected to be awake and listening for beacons from the AP. Since the color change operation may coincide with a TBTT, it may be desirable to ensure that the STAs belonging to a particular BSS do not frequently miss beacon transmissions from the AP. Thus, upon receiving a CCD message indicating a color collision has been detected, individual STAs may be configured to adjust their power save schedules, for example, to avoid sleeping for long durations (such as several consecutive TBTT intervals) that could cause the STA to miss a significant amount of beacon transmissions.

Then, at time t₃ (coinciding with TBTT_{CS}), the AP broadcasts a beacon frame with new BSS color information. In some aspects, the beacon frame may include a flow identifier indicating a BSS color change. More specifically, the beacon frame may include a “target wake time” (TWT) element that indicates the flow identifier. For example, the beacon frame broadcast during the color-switching time (TBTT_{CS}) may include a BSS color identifier with the new BSS color. More specifically, the AP may select a new color that is different than the color of any overlapping BSSs (or other BSSs in the vicinity of the AP). For example, during the color monitoring period (from times t₁ to t₂), the AP may gather information about the BSS color of neighboring APs. The AP may thus select a new color for its own BSS that does not conflict with the BSS color of any of its neighboring APs. After receiving the beacon frame, at time t₄, each of the associated stations STA1 and STA2 may “switch” to the new BSS color indicated in the received beacon frame and re-enable their respective color-related functionality. For example, the stations STA1 and STA2 may subsequently identify communication frames with the new BSS color as frames intended for their particular BSS.

In some implementations, the AP may coordinate the color change operation with its associated STAs to ensure that no service interruptions occur during the color changing process. For example, it may be desirable to ensure that all associated STAs are active (and listening) when the AP announces the color change (at the color-switching time). However, each of the STAs associated with a particular AP may have different wake-up schedules (such as listen intervals, power save periods, TWTs, and the like). Furthermore, some STAs may not wake up at regularly-scheduled TBTT intervals to receive beacon frames from the AP. For example, an AP may implement a TWT parameter to allocate individual timeslots (within a beacon interval) to service a subset of STAs. Any STAs operating in a TWT mode may wake up only during its assigned TWT service periods. Thus, the AP may take into consideration the wake-up schedules (or wake-up constraints) of each of its associated STAs to select and specify a color-switching time (TBTT_{CS}) when all (or at least most) of the STAs will be listening for beacon frames from the AP.

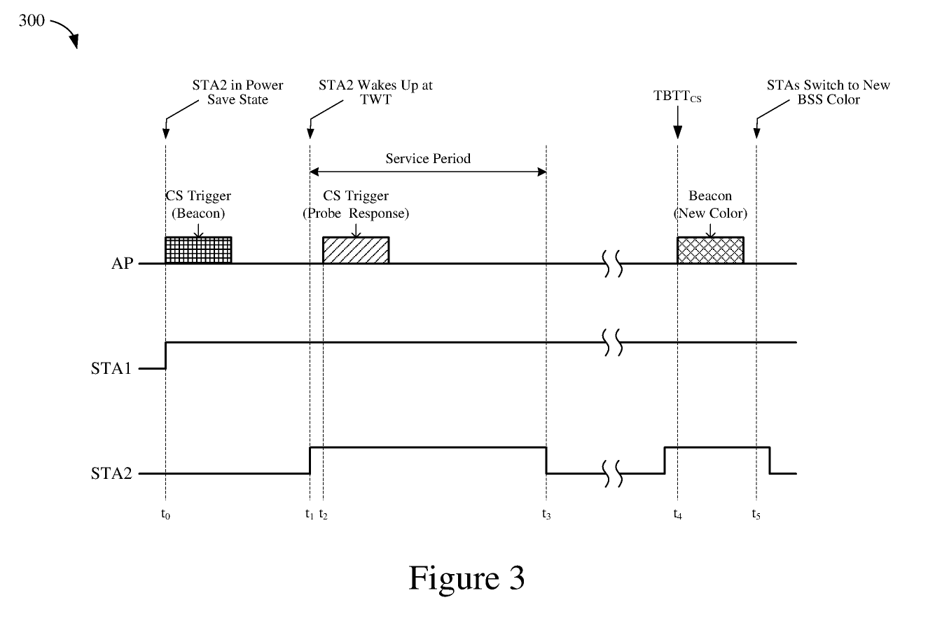

FIG. 3 shows a timing diagram 300 depicting a BSS color change operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 3. However, in some other implementations, the BSS may include fewer or more STAs than those depicted in the example of FIG. 3.

At time t₀, the AP may transmit a CS trigger message to the stations STA1 and STA2. For example, the CS trigger message may be embedded within a beacon frame broadcast by the AP. As described above, the CS trigger message may indicate a time (TBTT_{CS}) at which a color change operation is scheduled to occur. In the example of FIG. 3, STA1 is awake at time t₀, whereas STA2 is in a power saving state. For example, STA2 may operate in a TWT mode and therefore may not wake up at regularly-scheduled TBTT periods to receive beacon frames from the AP. As a result, STA1 may receive the CS trigger message, at time t₀, whereas STA2 may not. Upon receiving the CS trigger message, STA1 may ensure that it is awake prior to the scheduled color-switching time (TBTT_{CS}) to listen for BSS color changing information from the AP.

At time t₁, STA2 wakes up from its power save state to access the wireless medium. For example, time t₁ may coincide with the start of a TWT service period (from times t₁ to t₄) to which STA2 is assigned. In some implementations, the AP may transmit or broadcast CS trigger messages during scheduled TWT service periods, for example, to ensure that any STAs configured to operate in TWT mode (which may not wake up at regularly scheduled TBTT periods) are notified of the color-switching time (TBTT_{CS}). For example, as shown in FIG. 3, the AP may transmit a probe response frame (or an association or re-association frame) to STA2, at time t₂, after the STA wakes up from its power save state. In some implementations, the probe response frame (or the association or re-association frame) may include a CS trigger message indicating the time (TBTT_{CS}) at which the color change operation is scheduled to occur. For example, the probe response frame may specify or otherwise indicate a broadcast TWT service period (coinciding with TBTT_{CS}) at which any STAs operating in TWT mode are to wake up and listen for broadcast communications from the AP. Upon receiving the CS trigger message, STA2 may ensure that it is awake (or wake up) prior to the scheduled color-switching time (TBTT_{CS}) to listen for BSS color changing information from the AP.

In some aspects, the AP may communicate the CS trigger message to STA2 via an individually-addressed probe response frame. This may ensure reliable delivery of the CS trigger message to each associated STA. However, sending individually-address probe response frames to each STA also may consume a greater amount of time and bandwidth of the wireless medium. In some other aspects, the AP may communicate the CS trigger message to STA2 via a broadcast probe response frame that is addressed to all STAs that are awake during the TWT service period (from times t₁ to t₃). This may be a more efficient way to deliver the CS trigger message to each associated STA. However, broadcast probe response frames may not be as reliable as individually-addressed probe response frames for purposes of delivering the CS trigger message to its intended recipients.

In some implementations, rather than indicate a specific color-switching time (TBTT_{CS}), the probe response frame sent by the AP (at time t₂) may simply include a CCD message indicating that a color collision has been detected. For example, the AP may activate a corresponding bit in the HE Operation field of the probe response frame (as described above with respect to FIGS. 2A and 2B). After receiving the CCD message, STA2 may wake up (to listen for beacons) more frequently, for example, until the color change operation occurs (at time t₄). In some other implementations, the AP may communicate the CS trigger message to STA2 using a TWT action frame. For example, the CS trigger message may be provided in a TWT information field of the action frame. More specifically, the flow identifier may indicate a new broadcast scheduled to occur during the color-switching time (TBTT_{CS}).

Then, at time t₄ (coinciding with TBTT_{CS}), the AP broadcasts a beacon frame with new BSS color information. In some aspects, the beacon frame may include a flow identifier indicating a BSS color change. For example, the beacon frame broadcast during the color-switching TBTT may include a BSS color identifier with the new BSS color. As described above, the AP may select a new color that is different than the color of any overlapping BSSs (or other BSSs in the vicinity of the AP). In some implementations, after the color change operation is performed, subsequent beacon transmissions by the AP may include information indicating that a color change occurred at a prior time (such as at time t₄). This may further ensure that each STA belonging to the BSS is properly notified of the color change, including any STAs that may have been asleep during the color-switching time (TBTT_{CS}) or otherwise unable to receive the beacon with the color change information.

In the example of FIG. 3, STA1 remains awake when the color change operation occurs, at time t₄, whereas STA2 wakes up at (or just before) the color-switching time to receive the beacon frame with the new BSS color information. After receiving the beacon frame, at time t₅, each of the associated stations STA1 and STA2 may switch to the new BSS color indicated in the received beacon frame. For example, the stations STA1 and STA2 may subsequently identify communication frames with the new BSS color as frames intended for their particular BSS.

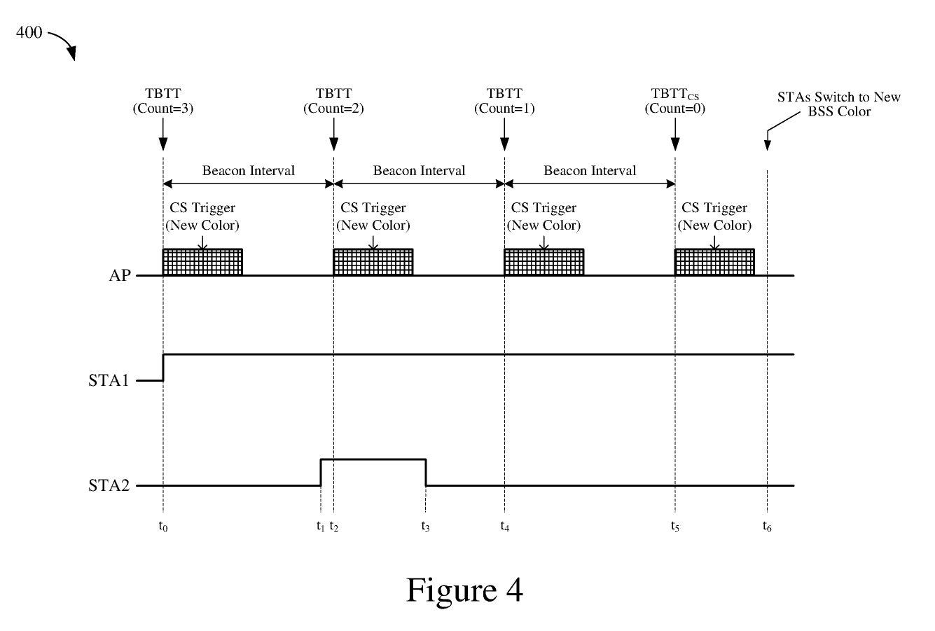

FIG. 4 shows a timing diagram 400 depicting a BSS color change operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 4. However, in some other implementations, the BSS may include fewer or more STAs than those depicted in the example of FIG. 4.

At time t₀, the AP may transmit a CS trigger message to one or more of the stations STA1 and STA2. For example, the CS trigger message may be embedded within a beacon frame (or other management, control, action, data, or communication frame) broadcast or transmitted by the AP at the start of a beacon (or TBTT) interval. In some implementations, the CS trigger message may indicate the new BSS color that is scheduled to take effect at a particular color-switching time (TBTT_{CS}), as well as a countdown towards the color-switching time. For example, the countdown may indicate the number of TBTT periods or beacon intervals remaining before the color change operation is scheduled to occur. Thus, as shown in FIG. 4, the CS trigger message transmitted at time t₀ may include a countdown timer indicating that the color change operation is to occur in three successive beacon intervals (Count=3). In the example of FIG. 4, STA1 is awake at time t₀, whereas STA2 is in a power saving state. As a result, STA1 may receive the CS trigger message, at time t₀, whereas STA2 may not. Upon receiving the CS trigger message, STA1 may be configured to switch to the new BSS color at the indicated color-switching time (after three successive TBTTs).

At time t₁, STA2 wakes up from its power save state to access the wireless medium. For example, time t₁ may coincide with a DTIM interval for which most (if not all) of the STAs in the BSS are scheduled to listen for beacon frames from the AP. Alternatively, or in addition, time t₁ may coincide with the start of a TWT service period to which STA2 is assigned. Then, at time t₂, the AP may transmit another CS trigger message to one or more of the stations STA1 and STA2. For example, the CS trigger message may be embedded within a beacon frame (or other management, control, action, data, or communication frame) broadcast or transmitted by the AP at the start of a beacon interval. As described above, the CS trigger message may include the new BSS color that is scheduled to take effect at the color-switching time (TBTT_{CS}), as well as an updated countdown timer (Count=2). The stations STA1 and STA2 may each receive the CS trigger message at time t₂. Upon receiving the CS trigger message, STA2 may be configured to switch to the new BSS color at the indicated color-switching time (after two successive TBTTs).

At time t₃, STA2 returns to a power saving state. Then, at time t₄, the AP transmits another CS trigger message to one or more of the stations STA1 and STA2. The CS trigger message, transmitted at time t₄, may indicate the new BSS color that is scheduled to take effect at the color-switching time (TBTT_{CS}), as well as an updated countdown timer (Count=1). STA1 may receive this CS trigger message, whereas STA2 may not (since it is in a power saving state). Nonetheless, STA2 may continue counting down the number of beacon intervals until the color change operation is to occur (at TBTT_{CS}), for example, based on the countdown timer received, at time t₂, via the CS trigger message.

Finally, at time t₅, the AP transmits another CS trigger message to one or more of the stations STA1 and STA2. In the example of FIG. 4, time t₅ coincides with the color-switching time (TBTT_{CS}). Thus, the CS trigger message may indicate the new BSS color, as well as an updated countdown timer (Count=0) indicating that the new BSS color is to take effect at this time. STA1 may receive this CS trigger message and switch to the new BSS color, accordingly, at time t₆. However, STA2 may remain in a power saving state and therefore may not receive the CS trigger message transmitted at time t₅. Nonetheless, STA2 also may switch to the new BSS color, at time t₆ (or the next time it wakes up from the power save state), based on its own internal countdown towards the color-switching time (TBTT_{CS}).

As shown in FIG. 4, the stations STA1 and STA2 are not required to be awake at the color-switching time (TBTT_{CS}) in order to perform the color change. Accordingly, such implementations may provide a greater degree of flexibility for the stations STA1 and STA2 to operate in accordance with their pre-configured power save schedules. For example, the AP may accommodate the individual power save schedules of the respective STAs by providing all of the information necessary to perform the color change operation (at the color-switching time) when the STAs are awake and listening to the AP. In some implementations, after the color-switching time has passed, subsequent beacon transmissions by the AP may include information indicating that a color change occurred at a prior time (such as at time t₅). This may further ensure that each STA belonging to the particular BSS is properly notified of the color change, including any STAs that may not have received a CS trigger prior to the color-switching time (TBTT_{CS}).

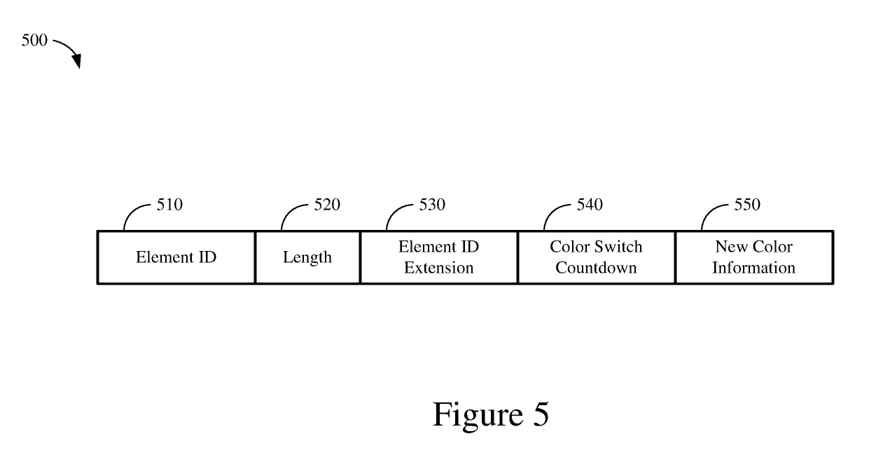

FIG. 5 shows an example BSS color change announcement element 500. In some implementations, the BSS color change announcement element 500 may correspond to a CS trigger message that may be provided within beacon frames, probe response frames, association or re-association frames, or various other communication frames that may be transmitted or broadcast by an AP to one or more STAs. The example BSS color change announcement element 500 includes an element identification (ID) field 510, a length field 520, an element ID extension field 530, a color switch countdown field 540, and a new color information field 550. Each of the fields 510-550 may be an octet in length.

The color switch countdown field 540 may include a countdown timer indicating the number of TBTT periods or beacon intervals until the color-switching time (TBTT_{CS}), and the new color information field 550 may indicate the new BSS color to be used at the given time. In some implementations, the new color information field 550 may be used to notify a STA of the new BSS color, prior to the color-switching time, so that the STA may switch to the new BSS color even if it is in a power save state at the time the new BSS color takes effect. In some aspects, the new color information field 550 may include six bits that are used to indicate the new BSS color, whereas the remaining two bits may be used for other information (such as an effective implementation of the BSS color, as described in greater detail below) or may be reserved for future use.

In some aspects, it may be desirable to continue honoring the old BSS color for a duration of time (such as one or more beacon intervals) after the scheduled color-switching time (TBTT_{CS}). For example, after providing the new BSS color information to its associated STAs, an AP may recognize or accept wireless communications tagged with (or indicating) either the new BSS color or the old BSS color for at least a threshold duration to allow the STAs to finish transmitting any buffered packets that may have already been tagged with the old BSS color. The “soft” transition from the old BSS color to the new BSS color also may provide additional time for any associated STAs, which may have missed one or more previously-transmitted CS trigger messages (carrying the new BSS color information), to identify and switch to the new BSS color before the AP begins using the new BSS color exclusively (corresponding to a “hard” color change).

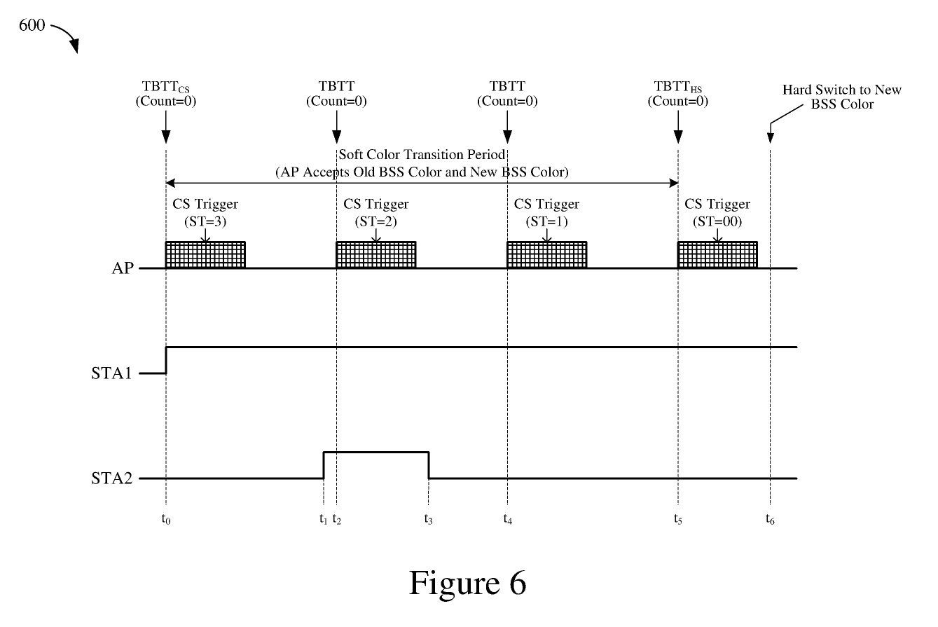

FIG. 6 shows a timing diagram 600 depicting a BSS color change operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 6. However, in some other implementations, the BSS may include fewer or more STAs than those depicted in the example of FIG. 6.

At time t₀, the AP may transmit a CS trigger message to one or more of the stations STA1 and STA2. As described above, the CS trigger message may be embedded within a beacon frame (or other management, control, action, data, or communication frame) broadcast or transmitted by the AP at the start of a beacon (or TBTT) interval. In FIG. 6, time t₀ coincides with a color-switching time (TBTT_{CS}). Thus, in some aspects, the CS trigger message may indicate a new BSS color, as well as a countdown timer (Count=0) indicating that the color-switching time has elapsed. In some implementations, the CS trigger message may further indicate that the old BSS color will no longer be recognized after a particular time. For example, after the color-switching time (TBTT_{CS}) occurs, the AP may recognize or accept wireless communications tagged with the new BSS color, as well as wireless communications tagged with the old BSS color, for at least a threshold duration (corresponding to a soft color transition period from times t₀ to t₅).

As described above, the soft color transition period may allow the stations STA1 and STA2 to finish transmitting any buffered packets that may have already been tagged with the old BSS color, and also may provide additional time for any associated STAs, which may have missed one or more previously-transmitted CS trigger messages (carrying the new BSS color information), to identify and switch to the new BSS color before the AP begins using the new BSS color exclusively.

In some aspects, the CS trigger message may indicate a “hard” color-switching time (TBTT_{HS}) at which the AP will no longer recognize or accept any communication frames tagged with the old BSS color. For example, the CS trigger message may include a soft transition (ST) value indicating the number of TBTT periods or beacon intervals remaining in the soft color transition period. Thus, as shown in FIG. 6, the CS trigger message transmitted at time t₀ may include an ST value indicating that the hard color-switching time (TBTT_{HS}) is to occur in three successive beacon intervals (ST=3). In the example of FIG. 6, STA1 is awake at time t₀, whereas STA2 is in a power saving state. As a result, STA1 may receive the CS trigger message, at time t₀, whereas STA2 may not. Upon receiving the CS trigger message, STA1 may be configured to switch to the new BSS color, if it has not already done so, on or before the hard color-switching time (TBTT_{HS}).

At time t₁, STA2 wakes up from its power save state to access the wireless medium. For example, time t₁ may coincide with a DTIM interval for which most (if not all) of the STAs in the BSS are scheduled to listen for beacon frames from the AP. Alternatively, or in addition, time t₁ may coincide with the start of a TWT service period to which STA2 is assigned. Then, at time t₂, the AP may transmit another CS trigger message to one or more of the stations STA1 and STA2. For example, the CS trigger message may be embedded within a beacon frame (or other management, control, action, data, or communication frame) broadcast or transmitted by the AP at the start of a beacon interval. As described above, the CS trigger message may include the new BSS color, a countdown timer (Count=0) indicating that a color-switching time (TBTT_{CS}) has already elapsed, and an ST value indicating that the AP will no longer recognize or accept wireless communications tagged with the old BSS color after two successive beacon intervals (ST=2). The stations STA1 and STA2 may each receive the CS trigger message at time t₂. Upon receiving the CS trigger message, STA2 may be configured to switch to the new BSS color, if it has not already done so, on or before the hard color-switching time (TBTT_{HS}).

At time t₃, STA2 returns to a power saving state. Then, at time t₄, the AP transmits another CS trigger message to one or more of the stations STA1 and STA2. The CS trigger message, transmitted at time t₄, may indicate the new BSS color that is already being used by the AP (as of TBTT_{CS}), as well as an updated ST value (ST=1). STA1 may receive this CS trigger message, whereas STA2 may not (since it is in a power saving state). Nonetheless, STA2 may continue counting down the number of beacon intervals until the hard color-switching time (TBTT_{HS}), for example, based on the ST value received, at time t₂, via the CS trigger message.

Finally, at time t₅, the AP transmits another CS trigger message to one or more of the stations STA1 and STA2. In the example of FIG. 6, time t₅ coincides with the hard color-switching time (TBTT_{HS}). Thus, the CS trigger message may indicate the new BSS color, as well as an updated ST value (ST=00) indicating that the AP will no longer recognize or accept wireless communications tagged with the old BSS color. For example, the AP may ignore or discard any wireless communications tagged with the old BSS color after time t₅. In some aspects, an ST value of “00” may signal a “hard switch” to the new BSS color (effective immediately). STA1 may receive this CS trigger message and switch to the new BSS color, if it has not already done so, at time t₆. However, STA2 may remain in a power saving state and therefore may not receive the CS trigger message transmitted at time t₅. Nonetheless, STA2 also may switch to the new BSS color, if it has not already done so, at time t₆ (or the next time it wakes up from the power save state), based on its own internal countdown to the hard color-switching time (TBTT_{HS}).

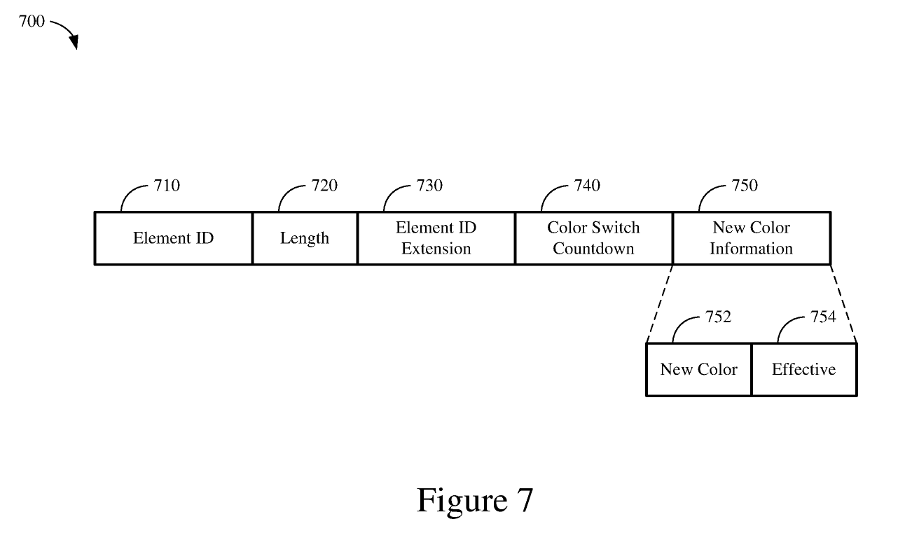

FIG. 7 shows an example BSS color change announcement element 700. In some implementations, the BSS color change announcement element 700 may correspond to a CS trigger message that may be provided within beacon frames, probe response frames, association or re-association frames, or various other communication frames that may be transmitted or broadcast by an AP to one or more STAs. The example BSS color change announcement element 700 includes an element identification (ID) field 710, a length field 720, an element ID extension field 730, a color switch countdown field 740, and a new color information field 750. Each of the fields 710-750 may be an octet in length.

The color switch countdown field 740 may include a countdown timer indicating the number of TBTT periods or beacon intervals until the color-switching time (TBTT_{CS}), and the new color information field 750 may indicate the new BSS color to be used at the given time. In some implementations, the new color information field 750 may be used to notify a STA of the new BSS color, prior to the color-switching time, so that the STA may switch to the new BSS color even if it is in a power save state at the time the new BSS color takes effect. In some implementations, the new color information field 750 may further include a new color subfield 752 and soft transition subfield 754. For example, the new color subfield 752 may include a six-bit BSS color identifier for the new BSS color, and the soft transition subfield 754 may correspond to a two-bit ST value indicating the hard color-switching time (TBTT_{HS}).

In addition to color collisions, overlapping BSSs also may have overlapping TBTTs. For example, with reference to FIG. 1, there may be instances where the first access point AP1 selects the same TBTT as the second access point AP2. As a result, the access points AP1 and AP2 may broadcast beacon frames at substantially the same times, causing the beacon frames broadcast by the first access point AP1 to “collide” or interfere with the beacon frames broadcast by the second access point AP2. Within BSS1, beacon collisions may hinder the ability of the stations STA1 and STA2 to receive intra-BSS beacons from the first access point AP1 (due to interference from inter-BSS beacon broadcasts by the second access point AP2). Within BSS2, beacon collisions may hinder the ability of the stations STA3 and STA4 to receive intra-BSS beacons from the second access point AP2 (due to interference from inter-BSS beacon broadcasts by the first access point AP1).

In some aspects, an AP may determine the TBTT of an overlapping BSS by intercepting beacon transmissions intended for the overlapping BSS. In some other aspects, the STAs belonging to a particular BSS may detect and report beacon collisions to their associated AP. For example, a STA may detect multiple concurrent beacon broadcasts while listening for an inter-BSS beacon from its associated AP. Thus, a beacon collision may occur when a STA receives at least two beacon frames that are intended for different BSSs. In some implementations, the STA may transmit an Event Report frame to the AP that indicates the TBTT (or whether a beacon collision was detected) for each overlapping BSS. In this manner, the STA may assist the AP in determining how to adjust its TBTT to avoid beacon collisions with overlapping BSSs.

Upon detecting a beacon collision, it may be desirable to change the TBTT of at least one of the overlapping BSSs. Thus, in at least some implementations, at least one of the access points AP1 or AP2 may initiate a TBTT adjustment operation to dynamically adjust the timing of its own TBTT so that it does not interfere or overlap with the TBTT of the other AP. For example, the first access point AP1 may expedite or delay its TBTTs to offset the timing of its own beacon broadcasts relative to the timing of the beacon broadcasts by the second access point AP2. In some aspects, the AP may coordinate with its associated STAs to ensure that each STA belonging to the corresponding BSS is appropriately notified of the change in TBTTs.

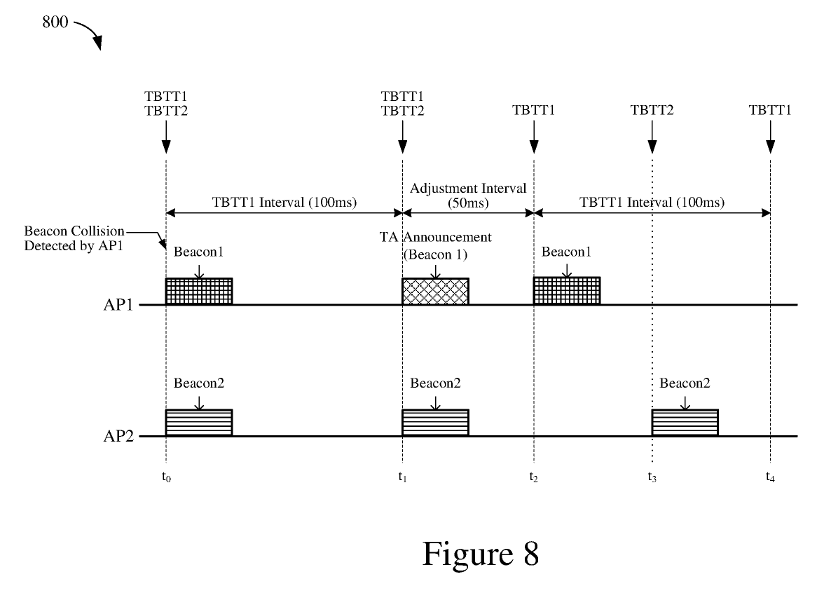

FIG. 8 shows a timing diagram 800 depicting an example TBTT adjustment operation. The access points AP1 and AP2 depicted in FIG. 8 may be implementations of AP1 and AP2, respectively, of FIG. 1. Although not shown for simplicity, one or more STAs may be associated with each of the access points AP1 and AP2 to collectively form respective BSSs (such as BSS1 and BSS2 of FIG. 1).

At time t₀, the first access point AP1 broadcasts a beacon frame (Beacon1) and detects a beacon collision based on a concurrent beacon broadcast by the second access point AP2. In some aspects, the first access point AP1 may detect the beacon collision by intercepting a beacon frame (Beacon2) broadcast by the second access point AP2. In some other aspects, the first access point AP1 may be notified of the beacon collision by one or more of its associated STAs (not shown). Upon detecting the beacon collision, the first access point AP1 may select a new TBTT to be implemented by the devices in its corresponding BSS. For example, the first access point AP1 may stagger its TBTTs (TBTT1) relative to the TBTTs (TBTT2) of the second access point AP2 to ensure that beacon frames broadcast by the first access point AP1 do not collide or interfere with beacon frames broadcast by the second access point AP2.

At time t₁, the first access point AP1 may initiate a TBTT adjustment operation. In some implementations, the first access point AP1 may trigger a TBTT adjustment operation by transmitting a TBTT adjustment (TA) announcement message to its associated STAs. In some aspects, the TA announcement message may indicate the timing of the new TBTTs. For example, the TA announcement message may indicate the time at which a new TBTT1 is to occur (such as an absolute time (t₃) or a duration of time (50 ms), referred to herein as an “adjustment” interval). In some other aspects, the TA announcement message may instruct the STAs to actively scan for beacons until the first access point AP1 transmits a subsequent beacon frame (at the new TBTT1). The first access point AP1 may communicate the TA announcement message to each of its associated STAs via broadcast, multicast, or unicast communications. For example, the TA announcement message may be embedded or otherwise encapsulated in management frames, control frames, action frames, data frames, or other communication frames.

It may be desirable to announce the TBTT adjustment at a time when all (or at least most) of the STAs of a particular BSS are listening to the AP. Thus, in some implementations, the first access point AP1 may transmit the TA announcement message during a TBTT, when its associated STAs expect to receive a beacon frame from the AP. In some aspects, the transmission of the TA announcement message may coincide with a Delivery Traffic Indication Map (DTIM) period, when most (if not all) of the STAs are expected to be awake and listening for beacons from the first access point AP1.

Then, at time t₂, the first access point AP1 broadcasts a subsequent beacon frame coinciding with the new TBTT1. In the example of FIG. 8, each of the access points AP1 and AP2 broadcasts beacon frames at 100 ms beacon intervals. However, due to the adjustment of TBTT1 (from times t₁ to t₂), the new TBTT1 (at time t₂) occurs just 50 ms after the previous TBTT1 (at time t₁). In other words, the new TBTT1 is expedited by 50 ms relative to the time at which the next TBTT1 would otherwise have occurred (such as at time t₃). As a result, beacon frames broadcast by the first access point AP1 (such as at time t₂) do not collide or interfere with beacon frames broadcast by the second access point AP2 (such as a time t₃). In some implementations, the first access point AP1 may continue to maintain the same 100 ms beacon interval (from times t₂ to t₄) after adjusting the timing of TBTT1.

In some implementations, the first access point AP1 may coordinate the TBTT adjustment operation with its associated STAs to ensure that no service interruptions occur during the change in TBTT. For example, it may be desirable to ensure that all associated STAs are active (and listening) when the first access point AP1 announces the TBTT adjustment (such as at time t₁). However, each of the STAs associated with the first access point AP1 may have different wake-up schedules (such as listen intervals, power save periods, TWTs, and the like). Thus, the first access point AP1 may take into consideration the wake-up schedules of each of its associated STAs (or times at which the STAs are available to receive communications from AP1) to select and specify a TA announcement time when all (or at least most) of the STAs will be listening for beacon frames from the first access point AP1, or will have already received a TA announcement message from the first access point AP1. It is noted that the BSS color change mechanisms described herein (such as with respect to FIGS. 4-7) may be used to implement BSS color changes concurrently across each of the STAs belonging to a particular BSS. Thus, aspects of the disclosure may leverage the BSS color change mechanisms to perform TBTT adjustment operations (to ensure that each STA belonging to a particular BSS is able to implement the new TBTT at substantially the same time).

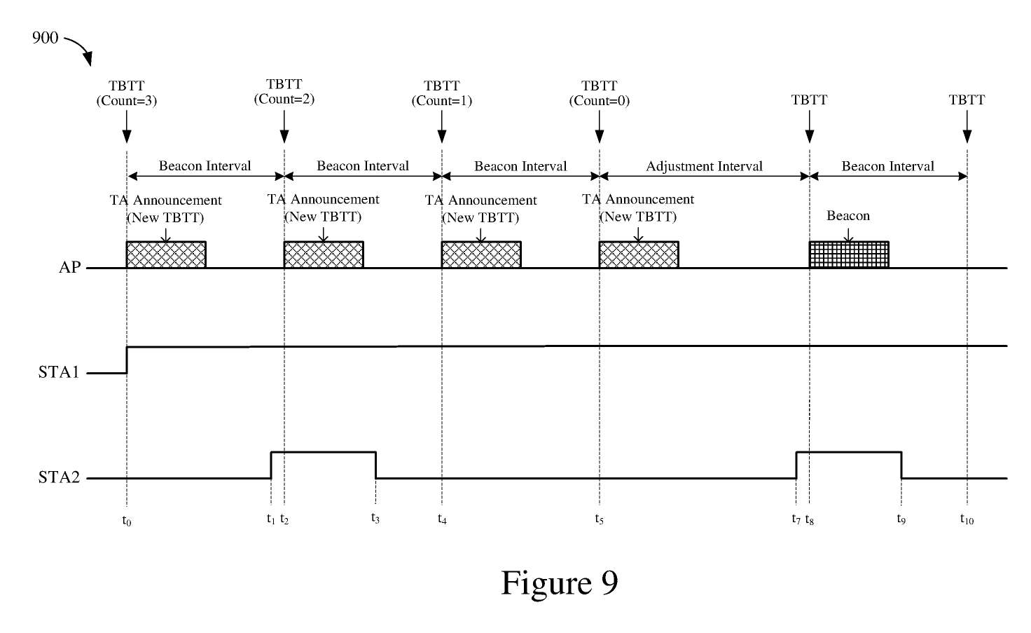

FIG. 9 shows a timing diagram 900 depicting an example TBTT adjustment operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 4. However, in some other implementations, the BSS may include fewer or more STAs than those depicted in the example of FIG. 9.

At time t₀, the AP may transmit a TA announcement message to one or more of the stations STA1 and STA2. For example, the TA message may be embedded, or otherwise encapsulated, within a beacon frame (or other management, control, action, data, or communication frame) broadcast or transmitted by the AP at the start of a beacon (or TBTT) interval. In some implementations, the TA announcement message may indicate the new TBTT that is scheduled to take effect during a particular TBTT adjustment interval (from times is to t₈), as well as a countdown towards the TBTT adjustment interval. For example, the countdown may indicate the number of TBTT periods or beacon intervals remaining before the start of the TBTT adjustment interval. Thus, as shown in FIG. 9, the TA announcement message transmitted at time t₀ may include a countdown timer indicating that the TBTT adjustment operation is to occur in three successive beacon intervals (Count=3). In the example of FIG. 9, STA1 is awake at time t₀ and STA2 is in a power saving state. As a result, STA1 may receive the TA announcement message, at time t₀, whereas STA2 may not. Upon receiving the TA announcement message, STA1 may be configured to implement the new TBTT after three successive TBTTs.

At time t₁, STA2 wakes up from its power save state to access the wireless medium. For example, time t₁ may coincide with a DTIM interval for which most (if not all) of the STAs in the BSS are scheduled to listen for beacon frames from the AP. Alternatively, or in addition, time t₁ may coincide with the start of a TWT service period to which STA2 is assigned. Then, at time t₂, the AP may transmit another TA announcement message to one or more of the stations STA1 and STA2. For example, the TA announcement message may be embedded, or otherwise encapsulated, within a beacon frame (or other management, control, action, data, or communication frame) broadcast or transmitted by the AP at the start of a beacon interval. As described above, the TA announcement message may indicate the new TBTT that is scheduled to take effect during the TBTT adjustment interval (from times t₅ to t₈), as well as an updated countdown timer (Count=2). The stations STA1 and STA2 may each receive the TA announcement message at time t₂. Upon receiving the TA announcement message, STA2 may be configured to switch to implement the new TBTT after two successive TBTTs (and STA1 may continue counting down to the start of the TBTT adjustment interval).

At time t₃, STA2 returns to a power saving state. Then, at time t₄, the AP transmits another TA announcement message to one or more of the stations STA1 and STA2. The TA announcement message, transmitted at time t₄, may indicate the new TBTT that is scheduled to take effect during the TBTT adjustment interval (from times t₅ to t₈), as well as an updated countdown timer (Count=1). STA1 may receive this TA announcement message, whereas STA2 may not (since it is in a power saving state). Nonetheless, STA2 may continue counting down the number of beacon intervals until the start of the TBTT adjustment interval (at time t₅), for example, based on the countdown timer received, at time t₂, via the TA announcement message.

At time t₅, the AP transmits another TA announcement message to one or more of the stations STA1 and STA2. In the example of FIG. 9, time t₅ coincides with the start of the TBTT adjustment interval. Thus, the TA announcement message may indicate the new TBTT, as well as an updated countdown timer (Count=0) indicating that the new TBTT is scheduled to take effect at this time. STA1 may receive the TA announcement message and immediately implement the new TBTT. For example, STA1 may begin listening for beacon broadcasts from the AP at the end of the TBTT adjustment interval (at time t₈). However, STA2 may remain in a power save state and therefore may not receive the TA announcement message transmitted at time t₅. Nonetheless, STA2 also may implement the new TBTT based on its own internal countdown towards the TBTT adjustment interval. For example, STA2 may wake up at a subsequent time coinciding with a new TBTT (such as at time t₇) to listen for beacon broadcasts from the AP.

As shown in FIG. 9, the stations STA1 and STA2 are not required to be awake during the TBTT adjustment interval to implement the new TBTT. Accordingly, such implementations may provide more flexibility for the stations STA1 and STA2 to operate in accordance with their pre-configured power save schedules. For example, the AP may accommodate the individual power save schedules of the respective STAs by providing the information necessary to perform the TBTT adjustment operation (during the TBTT adjustment interval) when the STAs are awake and listening to the AP.

In some implementations, the AP may leverage the BSS color change mechanisms described herein (such as with respect to FIGS. 4-7) to perform TBTT adjustment operations. For example, the TA announcement message may be encapsulated within a BSS color change announcement element. Thus, the BSS color change announcement element may be used to perform a BSS color change operation, a TBTT adjustment operation, or both. In some aspects, the BSS color change announcement element may be used to perform a BSS color change operation concurrently with a TBTT adjustment operation. In some other aspects, the BSS color change announcement element may be used to perform a TBTT adjustment operation without performing a BSS color change operation.

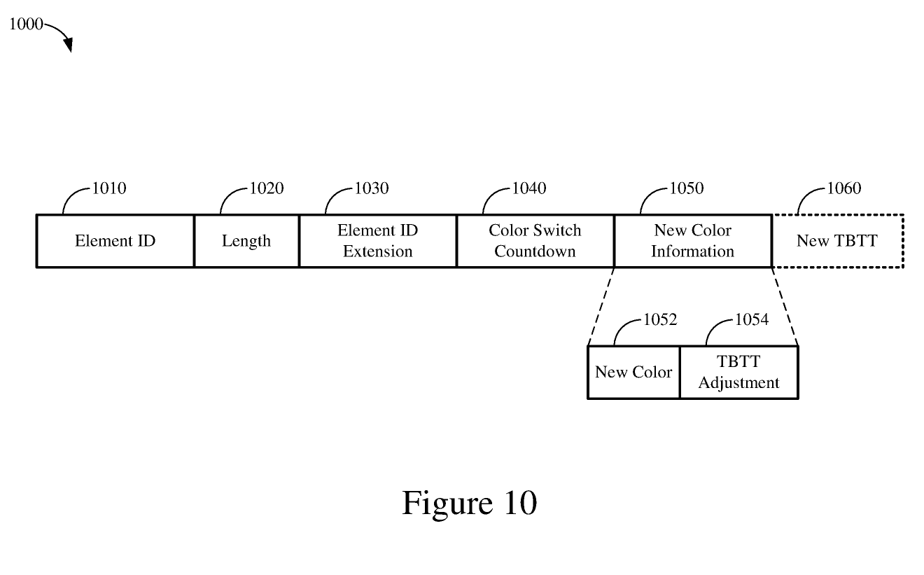

FIG. 10 shows an example BSS color change announcement element 1000 including TBTT adjustment information. In some implementations, the BSS color change announcement element 1000 may correspond to a TA announcement message (or a CS trigger message) that may be provided within beacon frames, probe response frames, association or re-association frames, or various other communication frames that may be transmitted or broadcast by an AP to one or more STAs. The example BSS color change announcement element 1000 includes an element identification (ID) field 1010, a length field 1020, an element ID extension field 1030, a color switch countdown field 1040, and a new color information field 1050. Each of the fields 1010-1050 may be an octet in length.

The color switch countdown field 1040 may include a countdown timer indicating the number of TBTT periods or beacon intervals until the start of the TBTT adjustment interval (or a color-switching time TBTT_{CS}), and the new color information field 1050 may indicate the BSS color to be used at the given time. In some implementations, the new color information field 1050 may further include a new color subfield 1052 and a TBTT adjustment subfield 1054. For example, the new color subfield 1052 may include a six-bit BSS color identifier and the TBTT adjustment subfield 1054 may include a single bit to indicate whether a TBTT adjustment operation is to be performed. Specifically, the TBTT adjustment subfield 1054 may be “activated” (indicating a bit value of “1”) when a TBTT adjustment operation is to be performed, and may be “deactivated” (indicating a bit value of “0”) when no TBTT adjustment operation is to be performed.

In some implementations, the new color subfield 1052 may indicate a new BSS color (when a change in BSS color is scheduled to occur). For example, when the new color subfield 1052 indicates a new BSS color, and the TBTT adjustment subfield 1054 is activated, the BSS color change announcement element 1000 may be configured to implement a BSS color change operation and a TBTT adjustment operation at the time indicated by the color switch countdown field 1040. In some other implementations, the new color subfield 1052 may indicate the same BSS color that is currently being used by the BSS (when no change in BSS color is scheduled to occur). For example, when the new color information field 1050 indicates the same BSS color that is currently being used, and the TBTT adjustment subfield 1054 is activated, the BSS color change announcement element 1000 may be configured to implement a TBTT adjustment operation without a corresponding change in BSS color.

In some implementations, the BSS color change announcement element 1000 may include a “new TBTT” field 1060 when a TBTT adjustment operation is to be performed. The new TBTT field 1060 may indicate the time at which a new TBTT is to occur (such as an absolute time or a duration of time, corresponding to an adjustment interval). In some aspects, the new TBTT field 1060 may be included in the BSS color change announcement element 1000 only when the TBTT adjustment subfield 1054 is asserted. In some other aspects, the new TBTT field 1060 may be included in the BSS color change announcement element 1000 only when the color switch countdown field 1040 reaches a count value of zero. Still further, in some aspects, the new TBTT field 1060 may be included in each BSS color change announcement element 1000 (regardless of whether the TBTT adjustment subfield 1054 is asserted). In some implementations, the new TBTT field 1060 may be provided elsewhere in a frame or packet that carries the BSS color change announcement element 1000 (rather than within the BSS color change element 1000 itself).

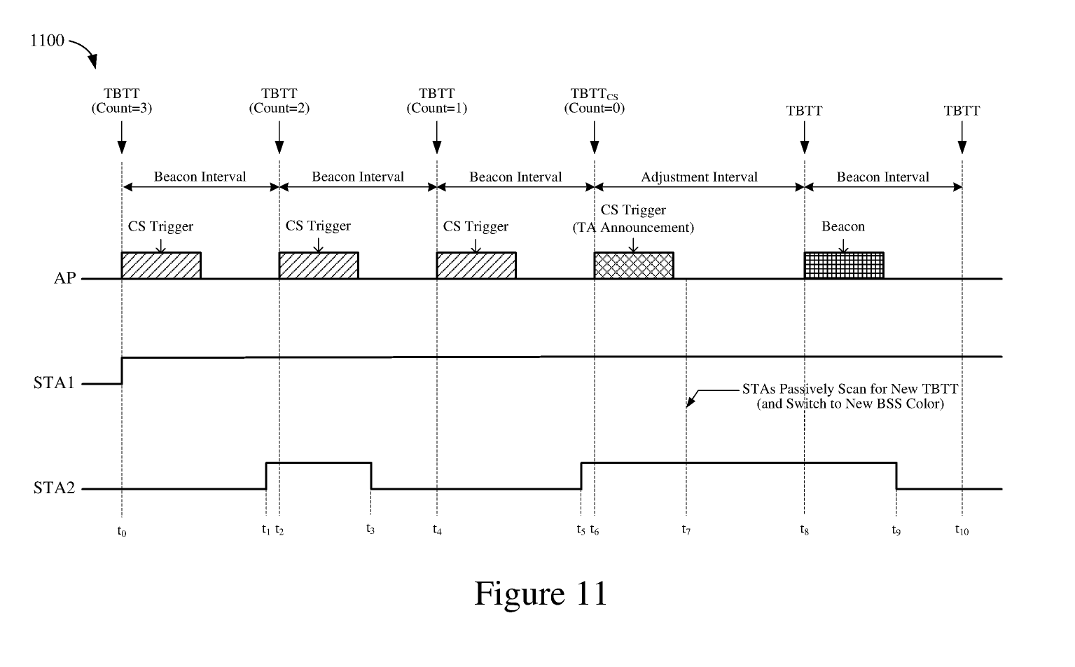

FIG. 11 shows a timing diagram 1100 depicting an example BSS color change and TBTT adjustment operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 11. However, in some other implementations, the BSS may include fewer or more STAs than those depicted in the example of FIG. 11.

At time t₀, the AP may transmit a CS trigger message to one or more of the stations STA1 and STA2. For example, the CS trigger message may be embedded, or otherwise encapsulated, within a beacon frame (or other management, control, action, data, or communication frame) broadcast or transmitted by the AP at the start of a beacon (or TBTT) interval. In some implementations, the CS trigger message may indicate the BSS color that is scheduled to take effect at a particular color-switching time (TBTT_{CS}), as well as a countdown towards the color-switching time. For example, the CS trigger message may indicate that a new BSS color is scheduled to take effect at the color-switching time or that the BSS color is to remain unchanged (when implementing only a TBTT adjustment operation). In some other implementations, the CS trigger message may further indicate that a new TBTT is scheduled to take effect at the color-switching time (such as by activating the TBTT adjustment subfield 1054 of the BSS color change announcement element 1000 of FIG. 10). The countdown may indicate the number of TBTT periods or beacon intervals remaining until the color-switching time. Thus, as shown in FIG. 11, the CS trigger message transmitted at time t₀ may include a countdown timer indicating that the color-switching time is to occur in three successive beacon intervals (Count=3). In the example of FIG. 11, STA1 is awake at time t₀ and STA2 is in a power saving state. As a result, STA1 may receive the CS trigger message, at time t₀, whereas STA2 may not. Upon receiving the CS trigger message, STA1 may be configured to listen for a TA announcement message from the AP at the color-switching time (after three successive TBTTs).

At time t₁, STA2 wakes up from its power save state to access the wireless medium. For example, time t₁ may coincide with a DTIM interval for which most (if not all) of the STAs in the BSS are scheduled to listen for beacon frames from the AP. Alternatively, or in addition, time t₁ may coincide with the start of a TWT service period to which STA2 is assigned. Then, at time t₂, the AP may transmit another CS trigger message to one or more of the stations STA1 and STA2. For example, the CS trigger message may be embedded, or otherwise encapsulated, within a beacon frame (or other management, control, action, data, or communication frame) broadcast or transmitted by the AP at the start of a beacon interval. As described above, the CS trigger message may indicate the BSS color that is scheduled to take effect at the color-switching time (TBTT_{CS}), as well as an updated countdown timer (Count=2). The CS trigger message may further indicate that a new TBTT is scheduled to take effect at the color-switching time. The stations STA1 and STA2 may each receive the CS trigger message at time t₂. Upon receiving the CS trigger message, STA2 also may be configured to listen for a TA announcement message from the AP at the color-switching time (after two successive TBTTs).

At time t₃, STA2 returns to a power saving state. Then, at time t₄, the AP transmits another CS trigger message to one or more of the stations STA1 and STA2. The CS trigger message, transmitted at time t₄, may indicate the BSS color that is scheduled to take effect at the color-switching time (TBTT_{CS}), as well as an updated countdown timer (Count=1). The CS trigger message may further indicate that a new TBTT is scheduled to take effect at the color-switching time. STA1 may receive this CS trigger message, whereas STA2 may not (since it is in a power saving state). Nonetheless, STA2 may continue counting down the number of beacon intervals until the color-switching time (TBTT_{CS}), for example, based on the countdown timer received, at time t₂, via the CS trigger message.

At time t₅, STA2 wakes up once again from its power save state to listen for a TA announcement message from the AP. Then, at time t₆, the AP transmits another CS trigger message to one or more of the stations STA1 and STA2. In the example of FIG. 11, time t₆ coincides with the color-switching time (TBTT_{CS}) as well as the start of the TBTT adjustment interval (from times t₆ to t₈). Thus, the CS trigger message may include a TA announcement message indicating that a new TBTT is scheduled to take effect at this time. The stations STA1 and STA2 may receive the TA announcement message and immediately implement the new BSS color (if applicable). Further, upon receiving the TA announcement message, each of the stations STA1 and STA2 may continue listening for beacon broadcasts until it receives a subsequent beacon from the AP at the new TBTT (time t₈). In the example of FIG. 11, STA2 may return to the power save state, at time t₉, after receiving the beacon associated with the new TBTT, and may remain in the power save state for the remainder of the beacon interval (from times t₉ to t₁₀)).

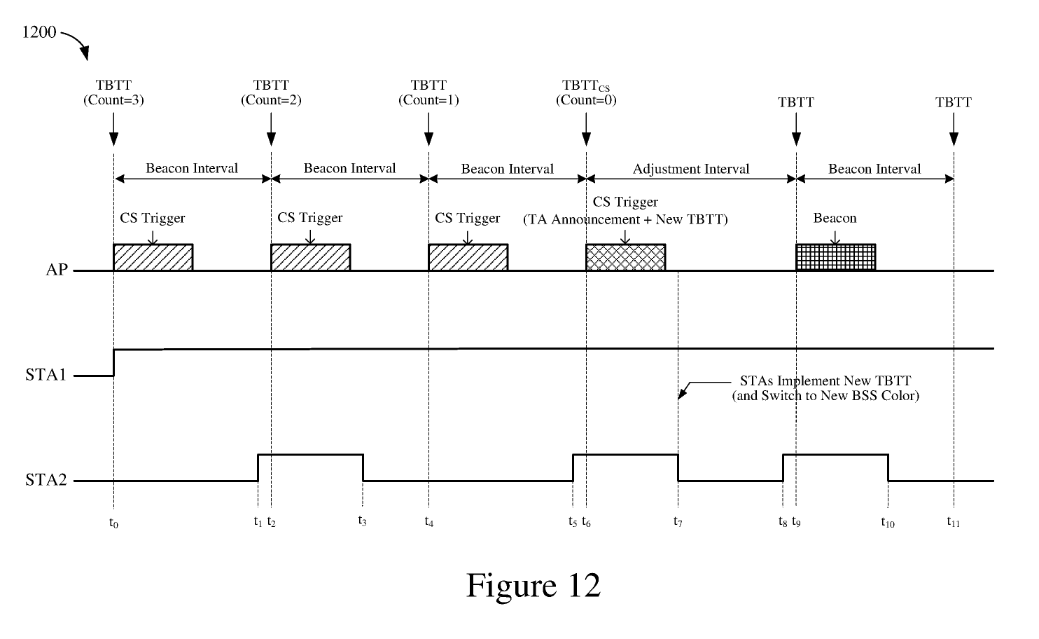

FIG. 12 shows a timing diagram 1200 depicting an example BSS color change and TBTT adjustment operation. The AP and stations STA1 and STA2 may be implementations of AP1 and stations STA1 and STA2, respectively, of FIG. 1. More specifically, the AP and stations STA1 and STA2 may belong to the same BSS (such as BSS1 of FIG. 1). For simplicity, only two stations STA1 and STA2 are shown in the example of FIG. 12. However, in some other implementations, the BSS may include fewer or more STAs than those depicted in the example of FIG. 12.

At time t₀, the AP may transmit a CS trigger message to one or more of the stations STA1 and STA2. For example, the CS trigger message may be embedded, or otherwise encapsulated, within a beacon frame (or other management, control, action, data, or communication frame) broadcast or transmitted by the AP at the start of a beacon (or TBTT) interval. In some implementations, the CS trigger message may indicate the BSS color that is scheduled to take effect at a particular color-switching time (TBTT_{CS}), as well as a countdown towards the color-switching time. For example, the CS trigger message may indicate that a new BSS color is scheduled to take effect at the color-switching time or that the BSS color is to remain unchanged (when implementing only a TBTT adjustment operation). In some other implementations, the CS trigger message may further indicate that a new TBTT is scheduled to take effect at the color-switching time (such as by activating the TBTT adjustment subfield 1054 of the BSS color change announcement element 1000 of FIG. 10). The countdown may indicate the number of TBTT periods or beacon intervals remaining until the color-switching time. Thus, as shown in FIG. 12, the CS trigger message transmitted at time t₀ may include a countdown timer indicating that the color-switching time is to occur in three successive beacon intervals (Count=3). In the example of FIG. 12, STA1 is awake at time t₀ and STA2 is in a power saving state. As a result, STA1 may receive the CS trigger message, at time t₀, whereas STA2 may not. Upon receiving the CS trigger message, STA1 may be configured to listen for a TA announcement message from the AP at the color-switching time (after three successive TBTTs).

At time t₁, STA2 wakes up from its power save state to access the wireless medium. For example, time t₁ may coincide with a DTIM interval for which most (if not all) of the STAs in the BSS are scheduled to listen for beacon frames from the AP. Alternatively, or in addition, time t₁ may coincide with the start of a TWT service period to which STA2 is assigned. Then, at time t₂, the AP may transmit another CS trigger message to one or more of the stations STA1 and STA2. For example, the CS trigger message may be embedded, or otherwise encapsulated, within a beacon frame (or other management, control, action, data, or communication frame) broadcast or transmitted by the AP at the start of a beacon interval. As described above, the CS trigger message may indicate the BSS color that is scheduled to take effect at the color-switching time (TBTT_{CS}), as well as an updated countdown timer (Count=2). The CS trigger message may further indicate the new TBTT that is scheduled to take effect at the color-switching time. The stations STA1 and STA2 may each receive the CS trigger message at time t₂. Upon receiving the CS trigger message, STA2 also may be configured to listen for a TA announcement message from the AP at the color-switching time (after two successive TBTTs).

At time t₃, STA2 returns to a power saving state. Then, at time t₄, the AP transmits another CS trigger message to one or more of the stations STA1 and STA2. The CS trigger message, transmitted at time t₄, may indicate the BSS color that is scheduled to take effect at the color-switching time (TBTT_{CS}), as well as an updated countdown timer (Count=1). The CS trigger message may further indicate the new TBTT that is scheduled to take effect at the color-switching time. STA1 may receive this CS trigger message, whereas STA2 may not (since it is in a power saving state). Nonetheless, STA2 may continue counting down the number of beacon intervals until the color-switching time (TBTT_{CS}), for example, based on the countdown timer received, at time t₂, via the CS trigger message.

At time t₅, STA2 wakes up once again from its power save state to listen for a TA announcement message from the AP. Then, at time t₆, the AP transmits another CS trigger message to one or more of the stations STA1 and STA2. In the example of FIG. 12, time t₆ coincides with the color-switching time (TBTT_{CS}) as well as the start of the TBTT adjustment interval (from times t₆ to t₉). Thus, the CS trigger message may include a TA announcement message with an updated countdown timer (Count=0) indicating that a new TBTT is scheduled to take effect at this time, as well as information indicating the time at which the new TBTT is to occur (such as an absolute time (t₉) or a duration of time (corresponding to the adjustment interval)). Each of the stations STA1 and STA2 may receive the TA announcement message and immediately implement the new TBTT (and new BSS color, if applicable). For example, STA1 may begin listening for beacon broadcasts from the AP at the end of the TBTT adjustment interval (at time t₉). In the example of FIG. 12, STA2 may return to the power save state, at time t₇, and may wake up at a subsequent time coinciding with the new TBTT (such as at time t₈) to listen for beacon broadcasts from the AP.

In some implementations, a BSS may include one or more legacy devices. As used herein, a “legacy STA” may refer to any wireless station that operates according to older IEEE 802.11 standards and may not support the HE frame format or protocol defined, for example, by the IEEE 802.11ax standards. For example, legacy STAs may operate according to the IEEE 802.11a/g or other “legacy” standards. Because legacy STAs do not support the HE frame format, legacy STAs may be unable to recognize or process CS trigger messages or TA announcement messages transmitted by an AP. However, legacy STAs still wake up at TBTTs (or DTIMs) to listen for beacons from an AP. To ensure that they do not miss any beacon frames transmitted by the AP, HE STAs and legacy STAs typically begin listening for beacons at least a brief duration before a scheduled TBTT occurs, and continue listening for beacons until at least a brief duration after the TBTT (or until a beacon frame is detected).

In some implementations, the AP may incrementally adjust its TBTT over a number of beacon (or DTIM) intervals, when most (if not all) of its associated STAs are configured to listen for beacons transmitted by the AP. Each incremental adjustment may result in a new TBTT that is still within the beacon scanning threshold of its associated STAs. Accordingly, aspects of the disclosure may enable the AP to implement dynamic TBTT adjustments for legacy STAs and HE STAs, concurrently. In some implementations, the TBTT adjustment subfield 1054 of the BSS color change announcement element 1000 (shown in FIG. 10) may include a two-bit value indicating whether an incremental TBTT adjustment is to occur during the next TBTT or DTIM period. For example, a “00” bit combination may indicate that no TBTT adjustment is to be performed, a “01” bit combination may indicate that the TBTT for the next beacon interval is to be shifted (delayed or expedited) by a threshold amount, a “10” bit combination may indicate that the TBTT for the next DTIM period is to be shifted by a threshold amount, and the “11” bit combination may be reserved.

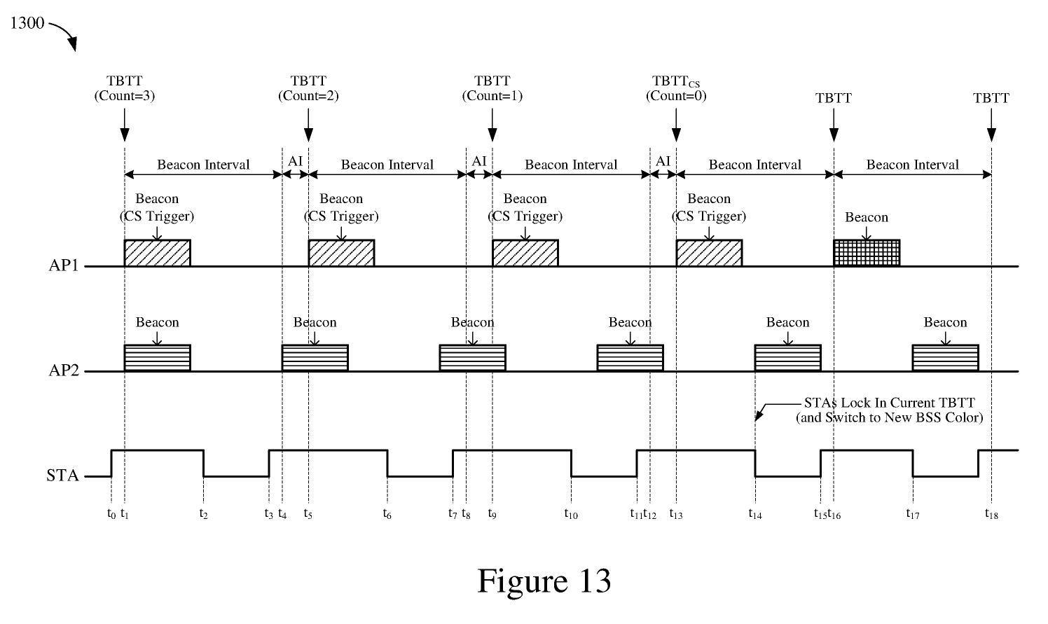

FIG. 13 shows a timing diagram 1300 depicting an example BSS color change and TBTT adjustment operation. The access points AP1 and AP2 depicted in FIG. 13 may be implementations of AP1 and AP2, respectively, of FIG. 1. The STA may be associated with the first access point AP1 to collectively form a BSS. In some implementations, the STA may be a legacy STA (not shown in FIG. 1) that does not support the HE frame format or BSS color functionality. For simplicity, only a single STA is shown in the example of FIG. 13. However, in some other implementations, the BSS may include fewer or more STAs (which may include legacy STAs and HE STAs) than those depicted in the example of FIG. 13.

In the example of FIG. 13, the first access point AP1 is configured to dynamically adjust its TBTT, and the second access point AP2 is configured to transmit beacons at regularly scheduled beacon intervals (without any TBTT adjustments). In some other implementations, the second access point AP2 also may be configured to dynamically adjust its TBTT. Prior to time t₀, the first access point AP1 may determine that its intra-BSS beacons are colliding with inter-BSS beacons from the second access point AP2 (such as by intercepting beacon frames transmitted by AP2 or receiving notifications from one or more associated STAs).

At time t₀, the STA wakes up from its power save state to listen for beacons from the first access point AP1. In some implementations, the STA may be configured to listen for beacons at each TBTT of the first access point AP1. In some other implementations, the STA may be configured to listen for beacons only during DTIM periods. Then, at time t₁, the first access point AP1 may transmit a beacon frame to the STA. In some implementations, the beacon frame may include a CS trigger message. For example, the CS trigger message may indicate that a new TBTT is scheduled to take effect at a particular color-switching time (TBTT_{CS}), as well as a countdown towards the color-switching time. In some implementations, the CS trigger message may indicate that no change in BSS color is to occur at the color-switching time. The countdown may indicate that the color-switching time is to occur in three successive TBTT (or DTIM) periods.

Upon receiving the CS trigger message, HE STAs (not shown for simplicity) associated with the first access point AP1 may be configured to listen for subsequent CS trigger messages from the first access point AP1 (at the scheduled TBTT or DTIM periods) until the countdown reaches zero. In the example of FIG. 13, the STA is a legacy device that may not recognize the information included in the CS trigger message. However, the STA may process other information provided in the beacon frame (which carries the CS trigger message), for example, to maintain connectivity with the first access point AP1. After receiving the beacon frame from the first access point AP1, the STA may return to a power saving state at time t₂. Because the STA last received a beacon frame at time t₁, the STA may expect to receive another beacon frame after a beacon interval has elapsed (from times t₁ to t₄). For example, time t₄ may coincide with the next expected TBTT (or DTIM) period based on the amount of elapsed time since the previous TBTT (or DTIM) period. Thus, the STA may wake up again at time t₃ to begin listening for beacon transmissions from the first access point AP1.

In some implementations, the first access point AP1 may delay the transmission of the next beacon frame (or CS trigger message) for the duration of an adjustment interval (AI), from times t₄ to t₅. Typically, a STA may disassociate with the first access point AP1 (or return to a power saving state) if it does not receive a beacon frame within at least a threshold duration of the expected TBTT. Thus, to prevent the STA from disassociating, the first access point AP1 may transmit the next beacon frame to the STA within a threshold duration after (or before) the expected TBTT. In the example of FIG. 13, the first access point AP1 transmits the next beacon frame at time t₅. In this manner, the first access point AP1 may incrementally delay (or expedite) its current TBTT (at time t₅) relative to its previous TBTT (which would have otherwise occurred at time t₄). In some implementations, the beacon frame may include a CS trigger message indicating that a new TBTT is scheduled to take effect at a particular color-switching time (TBTT_{CS}), as well as an updated countdown timer (Count=2). The countdown may indicate that the color-switching time is to occur in two successive TBTT (or DTIM) periods.

After receiving the beacon frame from the first access point AP1, the STA may return to its power save state, at time t₆, until the next TBTT (or DTIM) period. Because the STA last received a beacon frame at time t₅, the STA may expect to receive another beacon frame after a beacon interval has elapsed (from times t₅ to t₈). For example, time t₈ may coincide with the next expected TBTT (or DTIM) period based on the amount of elapsed time since the previous TBTT (or DTIM) period. Thus, the STA may wake up again at time t₇ to begin listening for beacon transmissions from the first access point AP1.

The first access point AP1 may once again delay the transmissions of the next beacon frame (or CS trigger message) for the duration of an adjustment interval, from times t₈ to t₉. As described above, to prevent the STA from disassociating, the first access point AP1 may transmit the next beacon frame to the STA within a threshold duration after (or before) the expected TBTT. In the example of FIG. 13, the first access point AP1 transmits the next beacon frame at time t₉. In this manner, the first access point AP1 may incrementally delay (or expedite) its current TBTT (at time t₉) relative to its previous TBTT (which would have otherwise occurred at time t₈). In some implementations, the beacon frame may include a CS trigger message indicating that a new TBTT is scheduled to take effect at a particular color-switching time (TBTT_{CS}), as well as an updated countdown timer (Count=1). The countdown may indicate that the color-switching time is to occur in one successive TBTT (or DTIM) period.

After receiving the beacon frame from the first access point AP1, the STA may return to its power save state, at time t₁₀), until the next TBTT (or DTIM) period. Because the STA last received a beacon frame at time t₉, the STA may expect to receive another beacon frame after a beacon interval has elapsed (from times t₉ to t₁₂). For example, time t₁₂ may coincide with the next expected TBTT (or DTIM) period based on the amount of elapsed time since the previous TBTT (or DTIM) period. Thus, the STA may wake up again at time t₁₁ to begin listening for beacon transmissions from the first access point AP1.

The first access point AP1 may once again delay the transmissions of the next beacon frame (or CS trigger message) for the duration of an adjustment interval, from times t₁₂ to t₁₃. In the example of FIG. 13, the first access point AP1 transmits the next beacon frame at time t₁₃. In this manner, the first access point AP1 may incrementally delay (or expedite) its current TBTT (at time t₁₃) relative to its previous TBTT (which would have otherwise occurred at time t₁₂). In some implementations, the beacon frame may include a CS trigger message with an updated countdown timer (Count=0) indicating that a new TBTT is scheduled to take effect at this time. Upon receiving the CS trigger message, HE STAs (not shown for simplicity) associated with the first access point AP1 may “lock in” the current TBTT (recognizing that no further TBTT adjustments are forthcoming).

After receiving the beacon frame from the first access point AP1, the STA may return to its power save state, at time t₁₄, until the next TBTT (or DTIM) period. Because the STA last received a beacon frame at time t₁₃, the STA may expect to receive another beacon frame after a beacon interval has elapsed (from times t₁₃ to t₁₆). Thus, the STA may wake up again at time t₁₅ to begin listening for beacon transmissions from the first access point AP1. By this time, the first access point AP1 has already adjusted the TBTT to the desired offset. Thus, the first access point AP1 may transmit the next beacon frame at time t₁₆ (corresponding to the next expected TBTT or DTIM period). The STA may return to its power save state, at time t₁₇, after receiving the beacon frame from the first access point AP1, and may wake up once again at the next expected TBTT, at time t₁₈, to receive a subsequent beacon frame from the first access point.

It is noted that, by time t₁₃, the beacon frames transmitted by the first access point AP1 no longer collide or interfere with the beacon frames transmitted by the second access point AP2. In other words, the first access point AP1 has successfully adjusted its TBTT by a desired amount of offset. However, in the example of FIG. 13, rather than implement a single large TBTT adjustment during a particular TBTT adjustment interval (such as shown in FIGS. 8, 9, 11, and 12), the first access point AP1 gradually adjusts its TBTT over multiple incremental adjustment intervals (from times t₄ to t₅, times t₈ to t₉, and times t₁₂ to t₁₃).

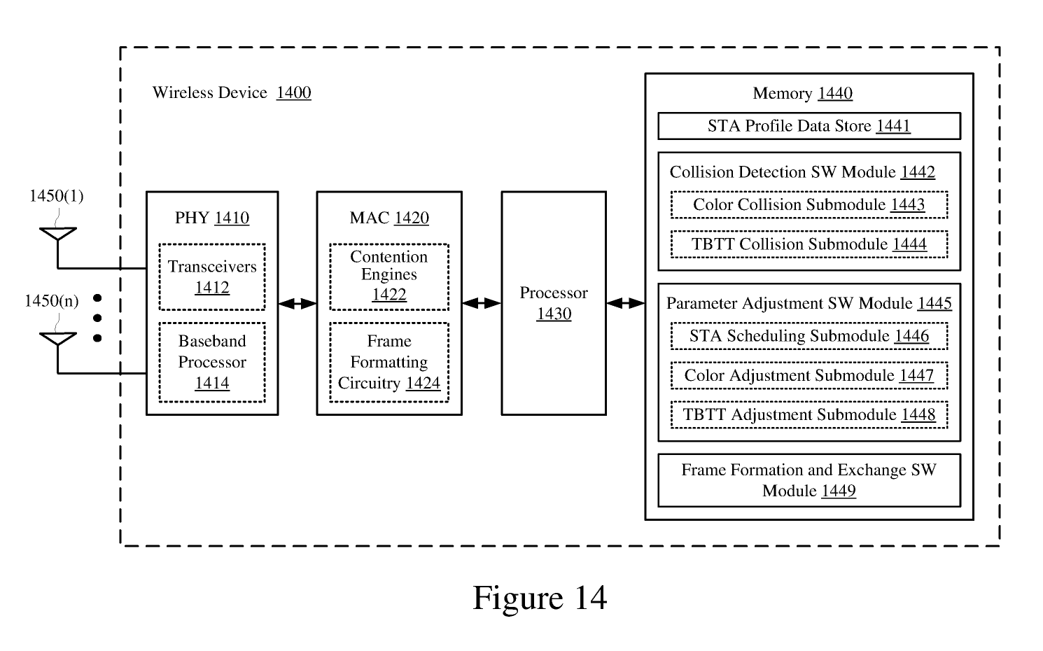

FIG. 14 shows a block diagram of an example wireless device 1400. In some implementations, the wireless device 1400 may be an access point that corresponds to, or provides, a respective BSS (referred to hereinafter as the “current BSS”). For example, the wireless device 1400 may be an implementation of any of the access points AP1 or AP2 of FIG. 1. The wireless device 1400 may include a PHY 1410, a MAC 1420, a processor 1430, a memory 1440, and a number of antennas 1450(1)-1450(n).

The PHY 1410 may include a number of transceivers 1412 and a baseband processor 1414. The transceiver 1412 may be coupled to the antennas 1450(1)-1450(n), either directly or through an antenna selection circuit (not shown for simplicity). The transceivers 1412 may be used to communicate wirelessly with one or more STAs, with one or more APs, or with other suitable devices. The baseband processor 1414 may be used to process signals received from the processor 1430 or the memory 1440 and to forward the processed signals to the transceivers 1412 for transmission via one or more of the antennas 1450(1)-1450(n), and may be used to process signals received from one or more of the antennas 1450(1)-1450(n) via the transceivers 1412 and to forward the processed signals to the processor 1430 or the memory 1440.

Although not shown in FIG. 14, for simplicity, the transceivers 1412 may include any number of transmit chains to process and transmit signals to other wireless devices via the antennas 1450(1)-1450(n), and may include any number of receive chains to process signals received from the antennas 1450(1)-1450(n). Thus, in some implementations, the wireless device 1400 may be configured for MIMO operations including, for example, single-user MIMO (SU-MIMO) operations and multi-user MIMO (MU-MIMO) operations. In addition, the wireless device 1400 may be configured for OFDMA communications or other suitable multiple access mechanisms, for example, as may be specified by any of the IEEE 802.11 standards, such as 802.11ax.

The MAC 1420 may include at least a number of contention engines 1422 and frame formatting circuitry 1424. The contention engines 1422 may contend for access to the shared wireless medium, and may store packets for transmission over the shared wireless medium. In some implementations, the contention engines 1422 may be separate from the MAC 1420. Still further, in some implementations, the contention engines 1422 may be implemented as one or more software modules (stored in the memory 1440 or in memory provided within the MAC 1420). The frame formatting circuitry 1424 may be used to create or format frames received from the processor 1430 or the memory 1440 (such as by adding MAC headers to PDUs provided by the processor 1430), and may be used to re-format frames received from the PHY 1410 (such as by stripping the MAC headers from frames received from the PHY 1410).

The memory 1440 may include a STA profile data store 1441 that stores profile information for a plurality of STAs. The profile information for a particular STA may include, for example, its MAC address, supported data rates, connection history with the wireless device 1400 (or the current BSS), one or more resource units (RUs) allocated to the STA, and any other suitable information pertaining to or describing the operation of the STA.

The memory 1440 also may include a non-transitory computer-readable medium (one or more nonvolatile memory elements, such as EPROM, EEPROM, Flash memory, a hard drive, and the like) that may store at least the following software (SW) modules:
a collision detection SW module 1442 to detect conflicts or collisions between one or more operating parameters of the current BSS and corresponding operating parameters of an overlapping BSS, the collision detection SW module 1442 including:
   a color collision submodule 1443 to detect instances where the current BSS and the overlapping BSS have the same BSS color; and
   a TBTT collision submodule 1444 to detect instances where a TBTT of the current BSS coincides with a TBTT of the overlapping BSS; and
a parameter adjustment SW module 1445 to dynamically adjust the one or more operating parameters that are in conflict with the overlapping BSS, the parameter adjustment SW module 1445 including:
   a STA scheduling submodule 1446 to determine times at which one or more STAs associated with the current BSS are available to receive communications from the wireless device 1400;
   a color adjustment submodule 1447 to change the BSS color of the current BSS based, at least in part, on the times at which the one or more STAs are available to receive communications from the wireless device 1400; and
   a TBTT adjustment submodule 1448 to change the TBTT of the current BSS based, at least in part, on the times at which the one or more STAs are available to receive communications from the wireless device 1400; and
a frame formation and exchange SW module 1449 to facilitate the creation and exchange of any suitable communication frames (such as beacon, probe response, or action frames) that may be used to communicate the change in the one or more operating parameters to the STAs associated with the current BSS.
   Each software module includes instructions that, when executed by the processor 1430, cause the wireless device 1400 to perform the corresponding functions.

For example, the processor 1400 may execute the collision detection SW module 1442 to detect conflicts or collisions between one or more operating parameters of the current BSS and corresponding operating parameters of an overlapping BSS. In executing the collision detection SW module 1442, the processor 1430 may further execute the color collision submodule 1443 or the TBTT collision submodule 1444. For example, the processor 1430 may execute the color collision submodule 1443 to detect instances where the current BSS and the overlapping BSS have the same BSS color. Further, the processor 1430 may execute the TBTT collision submodule 1444 to detect instances where a TBTT of the current BSS coincides with a TBTT of the overlapping BSS.

The processor 1400 also may execute the parameter adjustment SW module 1445 to dynamically adjust the one or more operating parameters that are in conflict with the overlapping BSS. In executing the parameter adjustment SW module 1445, the processor 1430 may further execute the STA scheduling submodule 1446, the color adjustment submodule 1447, or the TBTT adjustment submodule 1448. For example, the processor 1430 may execute the STA scheduling submodule 1446 to determine times at which one or more STAs associated with the current BSS are available to receive communications from the wireless device 1400. Further, the processor 1430 may execute the color adjustment submodule 1447 to change the BSS color of the current BSS based, at least in part, on the times at which the one or more STAs are available to receive communications from the wireless device 1400. Still further, the processor 1430 may execute the TBTT adjustment submodule 1448 to change the TBTT of the current BSS based, at least in part, on the times at which the one or more STAs are available to receive communications from the wireless device 1400.

The processor 1430 also may execute the frame formation and exchange SW module 1449 to facilitate the create and exchange of any suitable communication frames (such as beacon, probe response, or action frames) that may be used to communicate the change in the one or more operating parameters to the STAs associated with the current BSS.

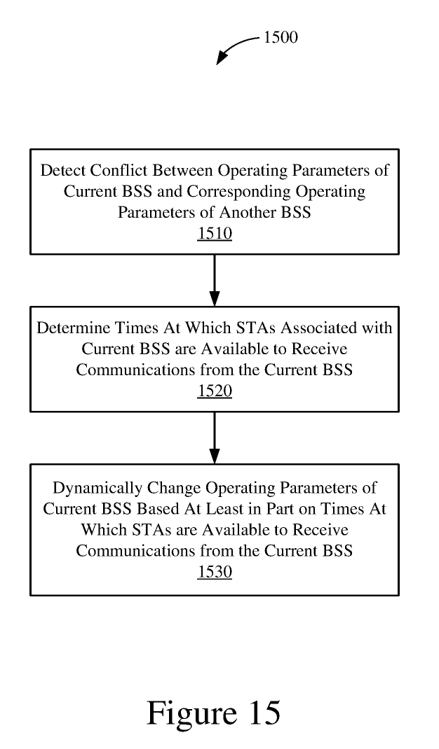

FIG. 15 shows a flowchart depicting an example operation 1500 for dynamically changing one or more operating parameters of a BSS. More specifically, the example operation 1500 may be performed by an AP to detect and mitigate conflicts or collisions between the operating parameters of its associated BSS (the “current BSS”) and corresponding operating parameters of an overlapping BSS. With reference for example to FIG. 1, the example operation 1500 may be performed by any of the access points AP1 or AP2.

The AP may detect a conflict between one or more operating parameters of the current BSS and corresponding operating parameters of another BSS (1510). For example, the operating parameters may affect a timing or identification of communications in each respective BSS. In some instances, the other BSS may at least partially overlap the current BSS. As a result, communications between the AP and its associated STAs may interfere with communications in the other BSS, while communications in the other BSS may interfere with communications between the AP and its associated STAs. In some implementations, the AP may detect conflicts or collisions with another BSS by intercepting communications from the other BSS. In some other implementations, the AP may detect conflicts or collisions with another BSS based on reports received from one or more of its associated STAs.

The AP further determines times at which one or more STAs associated with the current BSS are available to receive communications from the current BSS (1520). For example, it may be desirable to change the operating parameters that are in conflict with the other BSS at a time when all (or at least most) of the STAs associated with the current BSS are listening to the AP (such as a TBTT or DTIM period). In some aspects, the AP may determine the times at which the associated STAs are available to receive communications based, at least in part, on a wake-up schedule (such as listen intervals, power save periods, TWTs, and the like) for one or more of its associated STAs.

The AP may dynamically change the one or more operating parameters of the current BSS based, at least in part, on the times at which the associated STAs are available to receive communications from the current BSS (1530). For example, the AP may implement the change during a TBTT or DTIM period when most (if not all) of the STAs are expected to be awake and listening for beacons from the AP. In some implementations, the AP may schedule the change to occur at a future time, to provide each of its associated STAs sufficient opportunity to detect (or be notified of) the impending change. For example, the AP may periodically transmit or broadcast trigger messages indicating the changes to be implemented to one or more operating parameters of the current BSS and the time at which the changes are scheduled to take effect (such as by a countdown timer). The transmission of the trigger frames may coincide with TBTTs to increase the likelihood that STAs having different wake-up schedules will receive at least one of the trigger frames (and will thus be notified of the impending change) before the changes take effect.

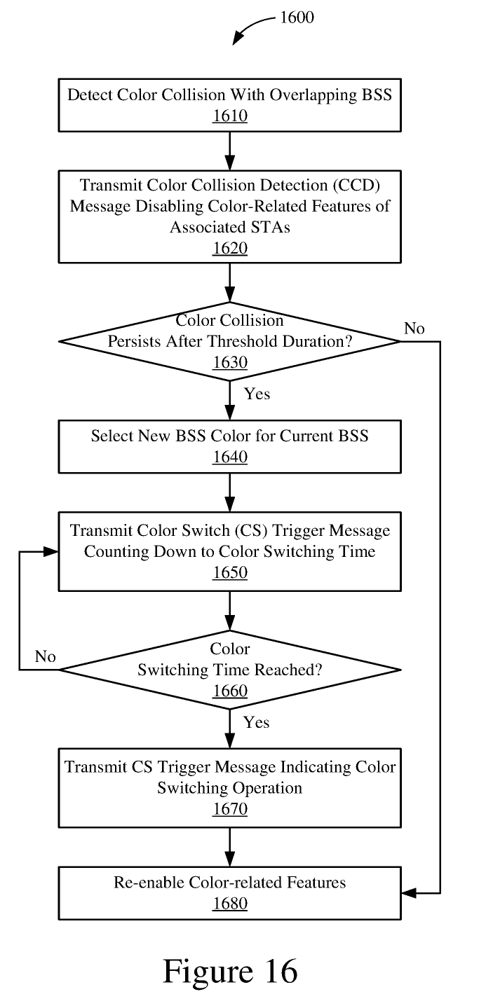

FIG. 16 shows a flowchart depicting an example operation 1600 for changing the BSS color of a BSS when a color collision is detected with an overlapping BSS. More specifically, the example operation 1600 may be performed by an AP to detect and mitigate color collisions between its associated BSS (the “current BSS”) and an overlapping BSS. With reference for example to FIG. 1, the example operation 1600 may be performed by any of the access points AP1 or AP2.

The AP may detect a color collision with an overlapping BSS (1610). For example, a color collision may occur when the BSS color of the current BSS is the same as the BSS color of an overlapping BSS. In some implementations, the AP may detect the color collision by analyzing the BSS color identifier of communication frames intercepted from the overlapping BSS. In some other implementations, the AP may be notified of the color collision by one or more of its associated STAs.

Upon detecting the color collision, the AP may transmit a color collision detection (CCD) message disabling one or more color-related features of its associated STAs (1620). For example, in some instances, a color collision may be caused by a mobile device (such as a SoftAP) moving through the vicinity of the current BSS. Thus, it may be desirable to temporarily disable the color-related features of the STAs in the current BSS (such as intra-PPDU power save, multi-NAV operation, spatial reuse, and the like) to determine whether the color collision is merely temporary, or more permanent. The CCD message may be embedded in management frames, control frames, action frames, data frames, or other communication frames. In some implementations, the AP may indicate that the STAs should disable their color-related functions by activating a corresponding bit in the HE Operation field of frames communicated to its associated STAs.

The AP may determine whether the color collision persists after a threshold duration has elapsed (1630). During this threshold duration (also referred to as a color monitoring period), the AP may determine whether the detected color collision is merely temporary (such as caused by a SoftAP moving through the environment) or more permanent (such caused by a fixed or stationary AP in the vicinity of the current BSS). In some implementations, any communications by the AP during the color monitoring period may include a CCD message indicating that the receiving STAs should continue to disable their color-related features.

If the color collision does not persist at the end of the threshold duration (as tested at 1630), the AP may re-enable the color-related features of the current BSS (1680). For example, the AP may determine that the color collision was merely temporary if the color collision does not persist at the end of the threshold duration. In some implementations, the AP may transmit another CCD message to its associated STAs to indicate that the STAs may re-enable their respective color-related functionality. For example, the AP may indicate that the STAs can re-enable their color-related functions by deactivating the corresponding bit in the HE Operation field of communication frames sent to the STAs.

If the color collision persists at the end of the threshold duration (as tested at 1630), the AP may select a new BSS color to be implemented for the current BSS (1640). For example, the AP may determine that the color collision is more permanent if the color collision persists at the end of the threshold duration. Accordingly, it may be desirable to trigger a BSS color change operation. The AP may select a new BSS color for its current BSS that is different than the BSS color of the overlapping BSS (and any other BSSs in the vicinity). For example, during the color monitoring period, the AP may gather information about the BSS color of neighboring APs (such as by intercepting communication frames intended for other BSSs or receiving reports from its associated STAs).

The AP may transmit a color switch (CS) trigger message counting down to a color switching time (1650). The CS trigger message may be embedded in management frames, control frames, action frames, data frames, or other communication frames. More specifically, the CS trigger message may indicate the new BSS color to be implemented for the current BSS, as well as the time at which the new BSS color is scheduled to take effect (also referred to as the color switching time). In some implementations, the AP may perform the color change operation during a TBTT, or a DTIM period, when most (if not all) of its associated STAs are expected to be awake and listening for beacons from the AP.

At each subsequent TBTT, the AP may determine whether the color switching time has been reached (1660). As long as the color switching time has not been reached (as tested at 1660), the AP may continue to transmit CS trigger messages with an updated countdown timer (1650). For example, since different STAs may have different wake-up schedules, the AP may periodically broadcast CS trigger messages (such as at each TBTT or TWT for an associated STA) with an updated countdown timer indicating the time (or number of TBTTs) remaining until the new BSS color is scheduled to take effect.

If the color switching time has been reached (as tested at 1660), the AP may transmit a CS trigger message indicating a color switching operation is to occur at this time (1670). For example, the CS trigger message may be provided in a beacon frame specifying the new BSS color in its BSS color identifier. In some implementations, the CS trigger message may further include an updated countdown timer indicating the color switching time has been reached. Thus, the new BSS color may be used by the AP and its associated STAs for any future communications in the current BSS. In some implementations, the AP may continue to recognize wireless communications indicating the old BSS color for at least a threshold duration (also referred to as a soft transition period) immediately following the color switching time (such as described with respect to FIG. 6).

The AP may further re-enable the color-related features (1680). For example, the color collision should no longer persist after switching to the new BSS color. In some implementations, the beacon frame transmitted at the color switching time may include another CCD message indicating that the STAs may re-enable their respective color-related functionality. For example, the AP may indicate that the STAs can re-enable their color-related functions by deactivating the corresponding bit in the HE Operation field of the beacon frame transmitted at the color switching time.

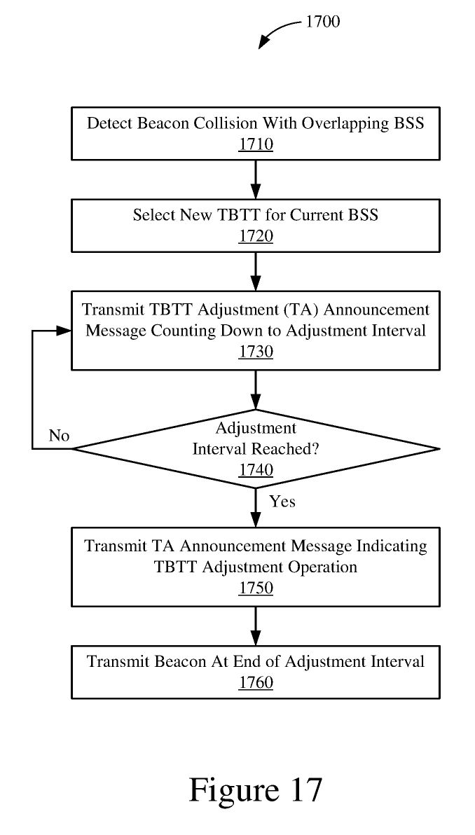

FIG. 17 shows a flowchart depicting an example operation 1700 for changing the TBTT of a BSS when a beacon collision is detected with an overlapping BSS. More specifically, the example operation 1700 may be performed by an AP to detect and mitigate beacon collisions between its associated BSS (the “current BSS”) and an overlapping BSS. With reference for example to FIG. 1, the example operation 1700 may be performed by any of the access points AP1 or AP2.

The AP may detect a beacon collision with an overlapping BSS (1710). For example, a beacon collision may occur when the current BSS transmits a beacon frame at substantially the same time as the overlapping BSS. In some implementations, the AP may detect the beacon collision by detecting or intercepting beacons transmitted by the overlapping BSS. In some other implementations, the AP may be notified of the beacon collision by one or more of its associated STAs.

Upon detecting the beacon collision, the AP may select a new TBTT to be implemented for the current BSS (1720). For example, the AP may adjust the timing of its beacon transmissions so that they do not coincide with beacon transmissions from the overlapping BSS (or from any other BSSs in the vicinity). In some implementations, the AP may offset its TBTT relative to the TBTT of the overlapping BSS by expediting or delaying its beacon transmissions (such that respective beacon transmission from the current BSS and the overlapping BSS are sufficiently separated in time).

The AP may transmit a TBTT adjustment (TA) announcement message counting down to an adjustment interval (1730). The TA announcement message may be embedded in management frames, control frames, action frames, data frames, or other communication frames. More specifically, the TA announcement message may indicate the timing of the new TBTT (such as the adjustment or offset to be applied to the current TBTT), as well as the time at which the new TBTT is scheduled to take effect (also referred to as the adjustment interval). In some implementations, the AP may perform the color change operation during a TBTT, or a DTIM period, when most (if not all) of its associated STAs are expected to be awake and listening for beacons from the AP.

At each subsequent TBTT, the AP may determine whether the adjustment interval has been reached (1740). As long as the adjustment interval has not been reached (as tested at 1740), the AP may continue to transmit TA announcement messages with an updated countdown timer (1730). For example, since different STAs may have different wake-up schedules, the AP may periodically broadcast TA announcement messages (such as at each TBTT or TWT for an associated STA) with an updated countdown timer indicating the time (or number of TBTTs) remaining until the new TBTT is scheduled to take effect.

If the adjustment interval has been reached (as tested at 1740), the AP may transmit a TA announcement message indicating a TBTT adjustment operation is to occur at this time (1750). For example, the TBTT adjustment operation may be effected based on the length or duration of the adjustment interval. More specifically, a longer adjustment interval may delay the TBTT of the current BSS relative to the TBTT of the overlapping BSS. On the other hand, a shorter adjustment interval may expedite the TBTT of the current BSS relative to the TBTT of the overlapping BSS. The AP may transmit a subsequent beacon frame at the end of the adjustment interval (1760). For example, the transmission of the subsequent beacon frame effectively terminates the adjustment interval and locks in the new TBTT for future communications.

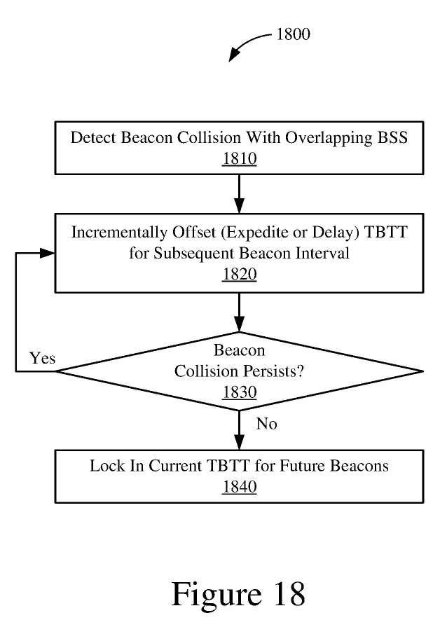

FIG. 18 shows a flowchart depicting another example operation 1800 for changing the TBTT of a BSS when a beacon collision is detected with an overlapping BSS. More specifically, the example operation 1800 may be performed by an AP to detect and mitigate beacon collisions between its associated BSS (the “current BSS”) and an overlapping BSS. With reference for example to FIG. 1, the example operation 1800 may be performed by any of the access points AP1 or AP2.

The AP may detect a beacon collision with an overlapping BSS (1810). For example, a beacon collision may occur when the current BSS transmits a beacon frame at substantially the same time as the overlapping BSS. In some implementations, the AP may detect the beacon collision by detecting or intercepting beacons transmitted by the overlapping BSS. In some other implementations, the AP may be notified of the beacon collision by one or more of its associated STAs.

Upon detecting the beacon collision, the AP may incrementally offset (such as by expediting or delaying) its TBTT for a subsequent beacon interval (1820). Aspects of this disclosure recognize that legacy STAs may be unable to recognize or process TA announcement messages that may be included in communications frames transmitted in accordance with the HE frame format. To ensure that legacy STAs do not miss any beacon frames, the AP may incrementally adjust the TBTT for the current BSS over a number of beacon (or DTIM) intervals. For example, each incremental adjustment may result in a new TBTT that is still within the previous beacon scanning threshold of its associated STAs.

At each subsequent TBTT, the AP may determine whether the beacon collision persists (1830). As long as the beacon collision persists (as tested at 1830), the AP may continue to expedite or delay its TBTT for a subsequent beacon interval (1820). In some implementations, the AP may determine a number of incremental offsets to be performed upon first detecting the beacon collision. The AP may thus assume that the beacon collision persists as long as the predetermined number of incremental offsets have not yet been performed. In some other implementations, the AP may periodically determine whether the beacon collision persists. For example, at each TBTT, the AP may detect whether the beacon collision still persists before performing any further adjustments to its TBTT.

If the beacon collision no longer persists (as tested at 1830), the AP may lock in the current TBTT for future beacon transmissions (1840). For example, the AP may cease incrementally adjusting the TBTT for the current BSS, and may time its transmission of future beacons in accordance with the current TBTT (with the applied offset).

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method, comprising:
detecting a conflict between one or more operating parameters of a first basic service set (BSS) and corresponding operating parameters of a second BSS;
determining times at which one or more wireless stations (STAs) associated with the first BSS are available to receive communications from the first BSS; and
dynamically changing the one or more operating parameters of the first BSS based at least in part on the times at which the one or more STAs are available to receive communications from the first BSS.

2. The method of claim 1, wherein the detecting comprises:
intercepting communications from the second BSS; and
determining, based on the intercepted communications, that the one or more operating parameters of the first BSS are the same as the corresponding operating parameters of the second BSS.

3. The method of claim 1, wherein the detecting comprises:
receiving a report from a STA associated with the first BSS; and
determining, based on information included in the report, that the one or more operating parameters of the first BSS are the same as the corresponding operating parameters of the second BSS.

4. The method of claim 1, wherein the times are based at least in part on respective wake-up schedules of the one or more STAs.

5. The method of claim 1, wherein the dynamically changing comprises:
selecting new values for the one or more operating parameters;
communicating the new values for the one or more operating parameters to the one or more STAs associated with the first BSS; and
implementing the new values for the one or more operating parameters at a scheduled time.

6. The method of claim 5, wherein the scheduled time is configured to coincide with at least one of a target beacon transmission time (TBTT) of the first BSS or a target wake time (TWT) of the one or more STAs.

7. The method of claim 5, wherein the scheduled time is indicated in one or more communication frames transmitted to each of the one or more STAs, and wherein each of the one or more communication frames includes a countdown timer indicating a number of TBTTs or TWTs remaining until the scheduled time.

8. The method of claim 1, wherein the one or more operating parameters includes a BSS color of the first BSS, and wherein the dynamically changing comprises:
disabling one or more features related to the BSS color of the first BSS upon detecting that the first BSS and the second BSS have the same BSS color; and
re-enabling the one or more features when the conflict is no longer detected in the BSS color of the first BSS.

9. The method of claim 8, wherein the one or more features includes at least one of spatial reuse, multiple-network allocation vector (multi-NAV) operation, or intra-physical layer convergence procedure protocol data unit (intra-PPDU) power save.

10. The method of claim 8, wherein the dynamically changing further comprises:
determining that the first BSS and the second BSS have the same BSS color after a threshold period has elapsed; and
selecting a new BSS color for the first BSS upon determining that the first BSS and the second BSS have the same BSS color after the threshold period has elapsed.

11. The method of claim 1, wherein the one or more operating parameters includes a TBTT of the first BSS, and wherein the dynamically changing comprises:
expediting or delaying the TBTT of the first BSS upon detecting that the TBTT of the first BSS coincides with the TBTT of the second BSS.

12. The method of claim 11, wherein the expediting or delaying comprises:
incrementally adjusting the TBTT of the first BSS, over a second duration, until the TBTT of the first BSS is offset relative to the TBTT of the second BSS by a threshold amount.

13. The method of claim 12, wherein the second duration corresponds to at least one of a plurality of beacon intervals or a plurality of delivery traffic indication message (DTIM) periods.

14. A wireless device, comprising:
one or more processors; and
a memory storing instructions that, when executed by the one or more processors, cause the wireless device to:
detect a conflict between one or more operating parameters of a first basic service set (BSS) and corresponding operating parameters of a second BSS;
determine times at which one or more wireless stations (STAs) associated with the first BSS are available to receive communications from the first BSS; and
dynamically change the one or more operating parameters of the first BSS based at least in part on the times at which the one or more STAs are available to receive communications from the first BSS.

15. The wireless device of claim 14, wherein execution of the instructions for detecting the conflict causes the wireless device to:
intercept communications from the second BSS; and
determine, based on the intercepted communications, that the one or more operating parameters of the first BSS are the same as the corresponding operating parameters of the second BSS.

16. The wireless device of claim 14, wherein execution of the instructions for detecting the conflict causes the wireless device to:
receive a report from a STA associated with the first BSS; and
determine, based on information included in the report, that the one or more operating parameters of the first BSS are the same as the corresponding operating parameters of the second BSS.

17. The wireless device of claim 14, wherein execution of the instructions for dynamically changing the one or more operating parameters causes the wireless device to:
select new values for the one or more operating parameters;
communicate the new values for the one or more operating parameters to the one or more STAs associated with the first BSS; and
implement the new values for the one or more operating parameters at a scheduled time.

18. The wireless device of claim 17, wherein the scheduled time is configured to coincide with a target beacon transmission time (TBTT) of the first BSS or a target wake time (TWT) of the one or more STAs.

19. The wireless device of claim 17, wherein the scheduled time is indicated in one or more communication frames transmitted to each of the one or more STAs, and wherein each of the one or more communication frames includes a countdown timer indicating a number of TBTTs or TWTs remaining until the scheduled time.

20. The wireless device of claim 14, wherein the one or more operating parameters includes a BSS color of the first BSS, and wherein execution of the instructions for dynamically changing the one or more operating parameters causes the wireless device to:
disable one or more features related to the BSS color of the first BSS upon detecting that the first BSS and the second BSS have the same BSS color; and
re-enable the one or more features when the conflict is no longer detected in the BSS color of the first BSS.

21. The wireless device of claim 20, wherein the one or more features includes at least one of spatial reuse, multiple-network allocation vector (multi-NAV) operation, or intra-physical layer convergence procedure protocol data unit (intra-PPDU) power save.

22. The wireless device of claim 20, wherein execution of the instructions for dynamically changing the one or more operating parameters further causes the wireless device to:
determine that the first BSS and the second BSS have the same BSS color after a threshold period has elapsed; and
select a new BSS color for the first BSS upon determining that the first BSS and the second BSS have the same BSS color after the threshold period has elapsed.

23. The wireless device of claim 14, wherein the one or more operating parameters includes a TBTT of the first BSS, and wherein execution of the instructions for dynamically changing the one or more operating parameters causes the wireless device to:
expedite or delay the TBTT of the first BSS upon detecting that the TBTT of the first BSS coincides with the TBTT of the second BSS.

24. The wireless device of claim 23, wherein execution of the instructions for expediting or delaying the TBTT of the first BSS causes the wireless device to:
incrementally adjust the TBTT of the first BSS, over a second duration, until the TBTT of the first BSS is offset relative to the TBTT of the second BSS by a threshold amount.

25. The wireless device of claim 24, wherein the second duration correspond to at least one of a plurality of beacon intervals or a plurality of delivery traffic indication message (DTIM) periods.

26. A method, comprising:
detecting a conflict between one or more operating parameters of a first basic service set (BSS) and corresponding operating parameters of a second BSS;
reporting the conflict to an access point (AP) associated with the first BSS; and
receiving a response from the AP indicating changes to the one or more operating parameters based at least in part on the reported conflict.

27. The method of claim 26, wherein the detecting comprises:
intercepting communications from the second BSS; and
determining, based on the intercepted communications, that the one or more operating parameters of the first BSS are the same as the corresponding operating parameters of the second BSS.

28. The method of claim 26, wherein the response includes new values for the one or more operating parameters, the method further comprising:
implementing the new values for the one or more operating parameters at a scheduled time, wherein the scheduled time is indicated in one or more communication frames received from the AP, and wherein each of the one or more communication frames includes a countdown timer indicating a number of target beacon transmission times (TBTTs) or target wake times (TWTs) remaining until the scheduled time.

29. The method of claim 26, wherein the one or more operating parameters includes a BSS color or a TBTT of the first BSS, the method further comprising:
disabling one or more features related to the BSS color, when communicating with the first BSS, based on the response from the AP, wherein the one or more features includes at least one of spatial reuse, multi-network allocation vector (multi-NAV) operation, or intra-physical layer convergence procedure protocol data unit (intra-PPDU) power save.

30. A wireless device, comprising:
one or more processors; and
a memory storing instructions that, when executed by the one or more processors, cause the wireless device to:
detect a conflict between one or more operating parameters of a first basic service set (BSS) and corresponding operating parameters of a second BSS;
report the conflict to an access point (AP) associated with the first BSS; and
receive a response from the AP indicating changes to the one or more operating parameters based at least in part on the reported conflict.
